(19) United States
(12) Patent Application Publication
(10) Pub. No.: US 2020/0024081 A1
(43) Pub. Date: Jan. 23, 2020

(54) FOOD TRANSPORTATION SYSTEM

(71) Applicant: Zume, Inc., Mountain View, CA (US)

(72) Inventors: Alexander John Garden, Tiburon, CA (US); Prashant Ghaiy, Campbell, CA (US); Vaibhav Goel, Santa Clara, CA (US); Joshua Gouled Goldberg, San Bruno, CA (US); Albert Martinez, Benicia, CA (US); Justin Osborn, Oakdale, CA (US); Tim Pletchet, Pleasanton, CA (US); Robert Switek, San Andreas, CA (US); Tobin Switek, Berkeley, CA (US); Paul Widergren, Livermore, CA (US)

(73) Assignee: Zume, Inc., Mountain View, CA (US)

(21) Appl. No.: 16/515,911

(22) Filed: Jul. 18, 2019

Related U.S. Application Data
(60) Provisional application No. 62/700,150, filed on Jul. 18, 2018.
(60) Provisional application No. 62/778,586, filed on Dec. 12, 2018.

(51) Int. Cl. B65G 47/90; A47J 47/14

(52) U.S. Cl. CPC B65G 47/90; B65G 2201/0202; A47J 47/14

(57) ABSTRACT

A system for transporting food items can include a rack having a plurality of shelves for holding and storing the food items, the rack supported on a plurality of wheels so that the rack can be pushed on the wheels. The system can include a shuttle on which the rack can be positioned, the shuttle and rack including features allowing the rack to be locked to and unlocked from the shuttle. The system can include a cooler, a frame, and other components to which the shuttle can be docked and the rack can be transferred from the shuttle. The system can include a robotic arm for loading food items onto the shelves of the rack. The system can include an elevator assembly for loading food items onto the shelves of the rack.

### CROSS REFERENCE TO RELATED APPLICATIONS

The present application claims the benefit of U.S. Provisional Patent Application No. 62/700,150, titled “FOOD TRANSPORTATION”, filed Jul. 18, 2018, and U.S. Provisional Patent Application No. 62/778,586, titled “FOOD TRANSPORTATION”, filed Dec. 12, 2018 which applications are hereby incorporated by reference.

### INTRODUCTION

This description generally relates to food transportation methods and equipment, such as robotic food transportation equipment having one or more moveable trays, one or more movable appendages, one or more elevator assemblies, or a combination thereof.

The preparation of hot food items by a restaurant has historically been a labor-intensive process. From fast-food locations to five-star restaurants, cooks, chefs, and other workers manually prepare food items to be served to customers, representing one of the biggest costs in the restaurant industry. In addition, the use of manual labor to prepare food items may also result in varied quality as different employees prepare food items, or even as the same employee prepares the same type of food item over the course of a shift.

Further, there are frequently mistakes in orders, with consumers receiving food they did not order, and not receiving food they did order. This can be extremely frustrating, and leaves the consumer or customer faced with the dilemma of settling for the incorrect order or awaiting a replacement order to be cooked and delivered.

### Food Transportation System

A food transportation system may be summarized as comprising: a rack including a plurality of shelves, a first bottom end portion, and a first pin extending vertically at the first bottom end portion; a food preparation appliance, such as a cooler, including a first latch sized to capture the first pin of the rack when the rack is positioned within the appliance, a second bottom end portion, and a second pin extending vertically at the second bottom end portion; and a shuttle including a second latch sized to capture the second pin of the appliance when the shuttle is docked with the appliance, a cover, and a release block extending vertically through the cover; wherein the rack includes a flange sized to capture the release block of the shuttle when the rack is positioned on the cover of the shuttle.

A system for moving food items may be summarized as comprising: a food item assembly line including a first conveyor belt that carries food items through the food item assembly line as the food items are assembled; a second conveyor belt positioned adjacent to the first conveyor belt to receive the food items from a terminal end portion of the first conveyor belt; and a robotic arm including an end-of-arm tool having a third conveyor belt positioned adjacent to the second conveyor belt to receive the food items from the second conveyor belt.

A method of moving a food item may be summarized as comprising: carrying the food item through a food item assembly line on a first conveyor belt at a first speed toward a terminal end of the first conveyor belt; adjusting an operating speed of a second conveyor belt positioned adjacent to the first conveyor belt to match the first speed; transferring the food item from the first conveyor belt to the second conveyor belt; moving a robotic arm including an end-of-arm tool having a third conveyor belt so that the third conveyor belt is positioned adjacent to the second conveyor belt; increasing the operating speed of the second conveyor belt to a second speed faster than the first speed; adjusting an operating speed of the third conveyor belt to match the second speed; and transferring the food item from the second conveyor belt to the third conveyor belt.

A food-item transfer system may be summarized as comprising: a base; a robotic appendage having a proximate end and a distal end, the robotic appendage moveably coupled to the base at the proximate end of the robotic appendage and selectively moveable to position the distal end of the robotic appendage with respect to the base; and an end-of-arm tool carried by the robotic appendage proximate the distal end of the robotic appendage, the end-of-arm tool including a conveyor belt and a push bar rigidly coupled to the conveyor belt at a coupling portion of the push bar, the push bar having a first end and a second end opposite the first end along an axis aligned with a direction of travel of the conveyor belt, the push bar including a forward face that faces away from the distal end of the robotic appendage at the first end of the push bar, the coupling portion of the push bar located at the second end of the push bar.

A method for moving a plurality of food items, including a first food item and a second food item, may be summarized as comprising: carrying the first food item through a food item assembly line on a conveyor belt toward a terminal end of the conveyor belt; transferring the first food item to a dispensing shelf; tilting the dispensing shelf towards a rack positioned on a platform at a first height level; raising the platform to a second height level; carrying the second food item through the food item assembly line on the conveyor belt toward the terminal end of the conveyor belt; transferring the second food item to the dispensing shelf; and tilting the dispensing shelf towards the rack positioned on the platform at the second height level.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure.

FIG. 1 is a perspective view of a system for transporting food items, according to at least one illustrated implementation.

FIG. 2 is another perspective view of the system for transporting food items of FIG. 1, according to at least one illustrated implementation.

FIG. 3 is a perspective view of a portion of an appliance of the system for transporting food items of FIGS. 1 and 2, according to at least one illustrated implementation.

FIG. 4 is a top plan view of a portion of the appliance of the system for transporting food items of FIGS. 1 and 2, according to at least one illustrated implementation.

FIG. 5 is a perspective view of a shuttle of the system for transporting food items of FIGS. 1 and 2, according to at least one illustrated implementation.

FIG. 6 is a perspective view of a portion of the shuttle of the system for transporting food items of FIGS. 1 and 2, according to at least one illustrated implementation.

FIG. 7 is a perspective view of another portion of the shuttle of the system for transporting food items of FIGS. 1 and 2, according to at least one illustrated implementation.

FIG. 8 is a perspective view of another portion of the shuttle of the system for transporting food items of FIGS. 1 and 2, according to at least one illustrated implementation.

FIG. 9 is a perspective view of another portion of the shuttle of the system for transporting food items of FIGS. 1 and 2, according to at least one illustrated implementation.

FIG. 10 is a perspective view of another portion of the shuttle of the system for transporting food items of FIGS. 1 and 2, according to at least one illustrated implementation.

FIG. 11 is a perspective view of another portion of the shuttle of the system for transporting food items of FIGS. 1 and 2, according to at least one illustrated implementation.

FIG. 12 is a perspective view of another portion of the shuttle of the system for transporting food items of FIGS. 1 and 2, according to at least one illustrated implementation.

FIG. 13 is a perspective view of a rack of the system for transporting food items of FIGS. 1 and 2, according to at least one illustrated implementation.

FIG. 14 is a perspective view of a portion of the rack of the system for transporting food items of FIGS. 1 and 2, according to at least one illustrated implementation.

FIG. 15 is a perspective view of another portion of the rack of the system for transporting food items of FIGS. 1 and 2, according to at least one illustrated implementation.

FIG. 16 is a perspective view of another portion of the rack of the system for transporting food items of FIGS. 1 and 2, according to at least one illustrated implementation.

FIG. 17 is a perspective view of a frame that can be used in combination with the system for transporting food items of FIGS. 1 and 2, according to at least one illustrated implementation.

FIG. 18 is another perspective view of the frame that can be used in combination with the system for transporting food items of FIGS. 1 and 2, according to at least one illustrated implementation.

FIG. 19 is a perspective view of a portion of the frame that can be used in combination with the system for transporting food items of FIGS. 1 and 2, according to at least one illustrated implementation.

FIG. 20 is a perspective view of a robotic arm that can be used in combination with the system for transporting food items of FIGS. 1 and 2, according to at least one illustrated implementation.

FIG. 21 is a perspective view of an end-of-arm tool of the robotic arm that can be used in combination with the system for transporting food items of FIGS. 1 and 2, according to at least one illustrated implementation.

FIG. 22 is another perspective view of the end-of-arm tool of the robotic arm that can be used in combination with the system for transporting food items of FIGS. 1 and 2, according to at least one illustrated implementation.

FIG. 23 is another perspective view of the end-of-arm tool of the robotic arm that can be used in combination with the system for transporting food items of FIGS. 1 and 2, according to at least one illustrated implementation.

FIG. 24 is another perspective view of the end-of-arm tool of the robotic arm that can be used in combination with the system for transporting food items of FIGS. 1 and 2, according to at least one illustrated implementation.

FIG. 25 is a perspective view of a portion of the end-of-arm tool of the robotic arm that can be used in combination with the system for transporting food items of FIGS. 1 and 2, according to at least one illustrated implementation.

FIG. 26 is another perspective view of a portion of the end-of-arm tool of the robotic arm that can be used in combination with the system for transporting food items of FIGS. 1 and 2, according to at least one illustrated implementation.

FIG. 27 is a perspective view of another portion of the end-of-arm tool of the robotic arm that can be used in combination with the system for transporting food items of FIGS. 1 and 2, according to at least one illustrated implementation.

FIG. 28 is a perspective view of another portion of the end-of-arm tool of the robotic arm that can be used in combination with the system for transporting food items of FIGS. 1 and 2, according to at least one illustrated implementation.

FIG. 29 is a schematic diagram of a control system that can be used in combination with the robotic arm that can be used in combination with the system for transporting food items of FIGS. 1 and 2, according to at least one illustrated implementation.

FIG. 30 is an overhead view of a rack feed system in a primary and secondary transfer position, and the rack feed system can be used in combination with the system for transporting food items of FIGS. 1 and 2, according to at least one illustrated implementation.

FIG. 31 a side view of a rack feed system in a primary and secondary transfer position, and the rack feed system can be used in combination with the system for transporting food items of FIGS. 1 and 2, according to at least one illustrated implementation.

FIG. 32 a perspective view of a rack feed system in a primary and secondary transfer position, and the rack feed system can be used in combination with the system for transporting food items of FIGS. 1 and 2, according to at least one illustrated implementation.

FIG. 33 is a perspective view of a rack feed system in a primary, pre-transfer position, and the rack feed system can be used in combination with the system for transporting food items of FIGS. 1 and 2, according to at least one illustrated implementation.

FIG. 34 is a perspective view of a rack feed system in a primary, post-transfer position, and the rack feed system can be used in combination with the system for transporting food items of FIGS. 1 and 2, according to at least one illustrated implementation.

FIG. 35 is a perspective view of a rack feed system in a secondary, pre-transfer position, and the rack feed system can be used in combination with the system for transporting food items of FIGS. 1 and 2, according to at least one illustrated implementation.

FIG. 36 is a top view of a rack feed system showing a first configuration of rack positions, and the rack feed system can be used in combination with the system for transporting food items of FIGS. 1 and 2, according to at least one illustrated implementation.

FIG. 37 is a top view of a rack feed system showing a second configuration of rack positions, and the rack feed system can be used in combination with the system for transporting food items of FIGS. 1 and 2, according to at least one illustrated implementation.

FIG. 38 is a top view of a rack feed system showing a first configuration of rack positions in an overload capacity, and the rack feed system can be used in combination with the system for transporting food items of FIGS. 1 and 2, according to at least one illustrated implementation.

FIG. 39 is a top view of a rack feed system showing a second configuration of rack positions in an overload capacity, and the rack feed system can be used in combination with the system for transporting food items of FIGS. 1 and 2, according to at least one illustrated implementation.

### DETAILED DESCRIPTION

Before the food transportation system designs and operational theory are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments of the pod dispensers only and is not intended to be limiting. It must be noted that, as used in this specification, the singular forms “a,” “an,” and “the” include plural referents unless the context clearly dictates otherwise. Thus, for example, reference to “a step” may include multiple steps, and reference to “producing” or “products” of a step or action should not be taken to be all of the products.

As used herein the terms “food”, “food item”, and “food product” refer to any item or product intended for human consumption. Although illustrated and described herein in the context of pizza to provide a readily comprehensible and easily understood description of one illustrative embodiment, one of ordinary skill in the culinary arts and food preparation will readily appreciate the broad applicability of the systems, methods, and apparatuses described herein across any number of prepared food products, including cooked and uncooked food items or products.

As used herein the terms “food preparation appliance” and, more simply, “appliance” refer to any device, system, or combination of systems and devices useful in the preparation of a food product which may include ingredient distribution devices, choppers, peeler, cooking units for the heating of food products, cooling units, refrigerators, ovens, cooking surfaces, smokers, basters, salters, mixers, blenders, etc. and preparation processes may also include the partial or complete preparation of one or more food products. Further, an appliance may be able to control one or more appliance operational parameters, including, in any combination of and without limitation, temperature, environment, pressure, humidity, airflow (to decrease preparation time), speed, time of start and end operation, pre-heat, and the like.

As used herein and in the claims the terms “robot” or “robotic” refer to any device, system, or combination of systems and devices that includes at least one appendage, typically with an end-of-arm tool or end effector, where the at least one appendage is selectively moveable to perform work or an operation useful in the preparation of a food item or packaging of a food item or food product. In some implementations, the robot may have a base that is fixed to a structure (e.g., floor) in the environment. In other implementations, the robot may include wheels, treads, or casters, and may even include a prime mover (e.g., electric traction motor) and may be self-propelled. The robot may be autonomously controlled, for instance based at least in part on information from one or more sensors (e.g., optical sensors used with machine-vision algorithms, position encoders, temperature sensors or thermocouples, moisture or humidity sensors). Alternatively, one or more robots can be remotely controlled by a human operator.

As used herein and in the claims the terms “joint” or “joints” refer to any physical coupling that permits relative movement between two members, typically referred to as links. A non-exhaustive list of examples of joints includes: revolute joints, prismatic joints, Hook's joints, spherical joints, screw joints, hinge joints, ball and socket joints, pivot joints, saddle joints, plane joints, ellipsoid joints, and universal joints, to name a few.

As used herein and in the claims the term “cooking unit” refers to any device, system, or combination of systems and devices useful in cooking or heating of a food product. While such preparation may include the heating of food products during preparation, such preparation may also include the partial or complete cooking of one or more food products. Additionally, while the term “oven” may be used interchangeably with the term “cooking unit” herein, such usage should not limit the applicability of the systems and methods described herein to only foods which can be prepared in an oven. For example, a hot skillet surface, a deep fryer, a microwave oven, and/or toaster can be considered a “cooking unit” that is included within the scope of the systems, methods, and apparatuses described herein. Further, the cooking unit may be able to control more than temperature. For example, some cooking units may control pressure and/or humidity. Further, some cooking units may control airflow therein, and thus may be able to operate in a convective cooking mode if desired, for instance to decrease cooking time.

As used herein, terms of relative elevation, such as “top,” “bottom,” “above,” “below,” etc., are used in accordance with their ordinary meanings, such that when a device is in use, gravity acts to pull items from the top of the device to the bottom of the device, and such that bubbles in water float from lower elevations upward to higher elevations.

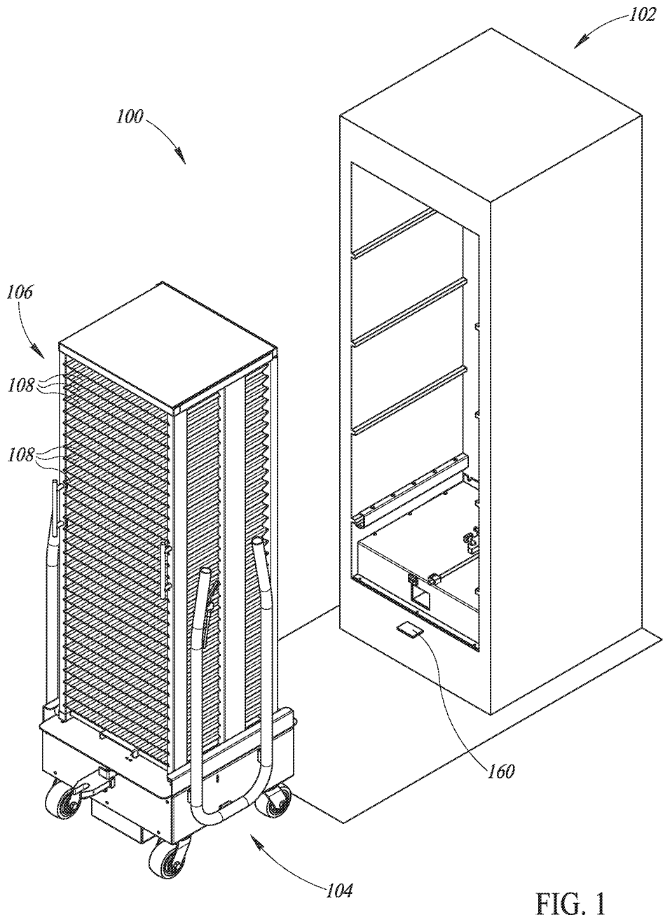

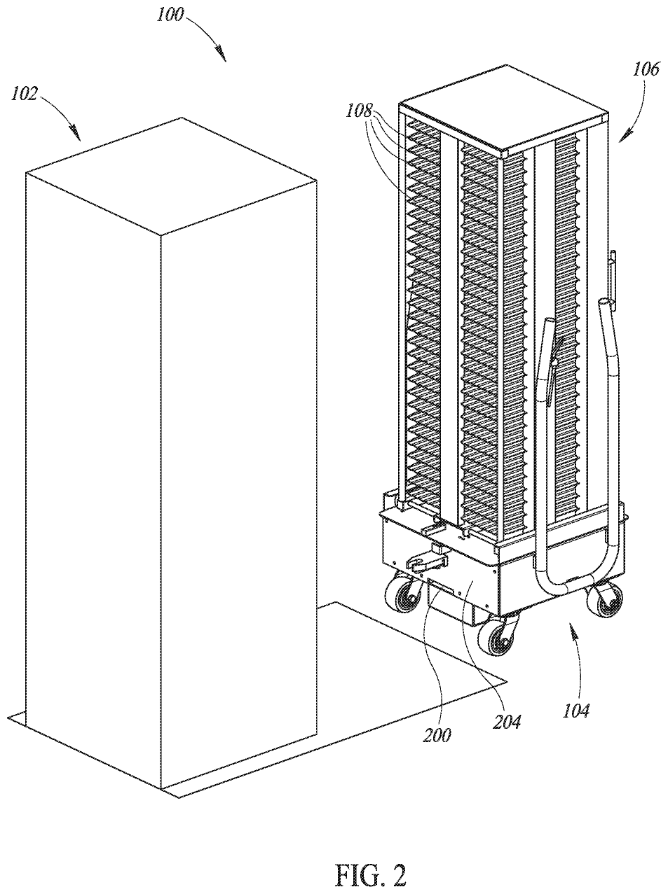

FIG. 1 illustrates a front perspective view of a system 100 including an appliance 102, a shuttle 104, and a cartridge or rack 106. In an embodiment, however, the appliance 102 may be any food preparation appliance as described above. FIG. 2 illustrates a rear perspective view of the system 100. As used herein in the context of the system 100 and/or the appliance 102, terms such as “front” and “back” have their ordinary meaning, such that an item located at the front of the system 100 or appliance 102 is located closer to a typical observer of the system 100 or appliance 102 than an item located at the back of the system 100 or appliance 102. Similarly, as used herein with respect to the system 100 and/or the appliance 102, terms such as “left” and “right” have their ordinary meaning, such as from the perspective of a typical observer from the front of the system 100 or appliance 102. The system 100 can be used to transport, store, and organize food items such as pizzas while held on the rack 106. For example, one or more pizzas can be positioned on respective shelves 108 of the rack 106, such as by a human operator or by a robotic system, as described in greater detail elsewhere herein. In addition, depending on the appliance 102, the system 100 can used to cook, pre-heat, pre-cook, post-heat, age, or to perform any preparation or cooking functions in addition to performing any transportation, storage, or organizational functions.

The rack 106 can be positioned on and mechanically docked, coupled, or locked to the shuttle 104 and the shuttle 104 can be operated, such as physically by a human operator, by an electronic control system under the direction of a human operator, or autonomously, to move the rack 106 from place to place within a an environment such as a food preparation environment, e.g., a kitchen. The shuttle 104 can carry the rack 106 to the appliance 102 and the shuttle 104 can dock with or be mechanically coupled or locked to the appliance 102. The rack 106 can be transferred from the shuttle 104 to the appliance 102 and can be positioned on and mechanically docked, coupled, or locked to the appliance 102, such as physically by a human operator, by an electronic control system under the direction of a human operator, or autonomously.

In an embodiment in which the appliance 102 is a cooler that maintains the temperature of the stored food items at an optimal storage temperature, the cooler 102 can include a front door that can be opened, closed, or removed from the rest of the cooler 102, and can be insulated and/or refrigerated in order to store food items held on the rack 106 for extended periods of time without degradation.

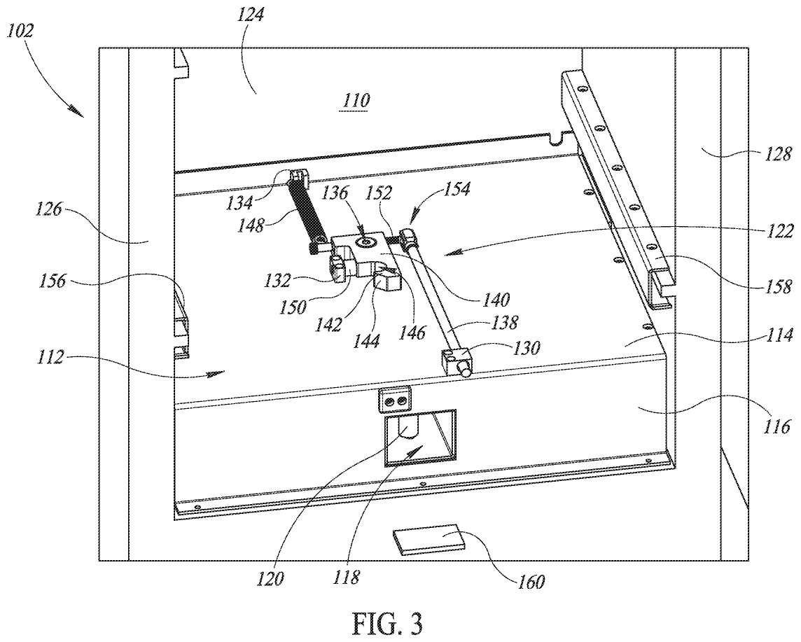

FIG. 3 illustrates a portion of the appliance 102 at a larger scale than that illustrated in FIGS. 1 and 2. In particular, FIG. 3 illustrates a bottom end of a storage cavity 110 within the appliance 102, where the storage cavity 110 is bounded at a rear end thereof by a rear wall 124 of the appliance 102, at a left side thereof by a left side wall 126 of the appliance 102, at a right side thereof by a right side wall 128 of the appliance 102, and at a bottom end thereof by a folded piece of sheet metal 112. The folded piece of sheet metal 112 is shaped and dimensioned to provide a flat, horizontal support surface 114 to support the rack 106 and a flat, vertical engaging surface 116 to engage with the shuttle 104. As illustrated in FIG. 3, the vertical engaging surface 116 includes an opening or recess 118 that is sunken or recessed backwards or rearward from a forward-facing portion of the engaging surface 116. The appliance 102 also includes a vertical locking pin 120 that extends vertically through the recess 118 from a center of a bottom surface of the recess 118 to a center of a top surface of the recess 118.

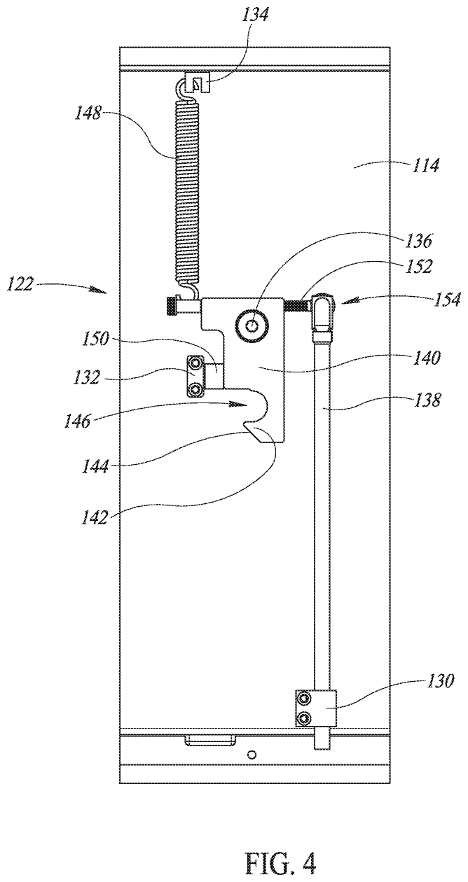

The appliance 102 also includes a mechanical latching system 122 coupled to the horizontal support surface 114 of the piece of sheet metal 112 at the bottom of the storage cavity 110. FIG. 4 illustrates a top plan view of the latching system 122. The latching system 122 includes a first support block 130, a second support block 132, a third support block 134, and a bearing 136, each of the support blocks 130, 132, and 134 and the bearing 136 rigidly coupled, such as by mechanical fasteners such as bolts, screws, etc., or by adhesives such as glues, epoxies, etc., to the appliance 102, such as to the horizontal support surface 114 of the piece of sheet metal 112 and/or to the rear wall 124 of the appliance 102.

The first support block 130 is coupled to the horizontal support surface 114 at a front lip or edge thereof and adjacent to the vertical engaging surface 116. The first support block 130 has a cylindrical aperture and conduit that extends longitudinally therethrough from a front end of the support block 130 to a rear end of the support block 130. The mechanical latching system 122 includes a rod 138 having a central longitudinal axis that extends from the front of the appliance 102 to the back of the appliance 102, and that extends through the conduit through the first support block 130. The support block 130 restrains the rod 138 against movement up-and-down and side-to-side such that the rod 138 can only move from front-to-back with respect to the rest of the appliance 102. In an embodiment, the rod 138 is prevented from rotating by its connection to the linkage bar 152 discussed below.

The mechanical latching system 122 includes a latch 140 having a tooth 142 with a beveled leading edge 144 that extends from front-to-back and from right-to-left as it extends across the horizontal support surface 114. The tooth 142 is separated from another portion of a body of the latch 140 by a gap or a recess 146, within which a pin of another component can be retained to prevent the other component from moving forward or rearward with respect to the appliance 102. The latch 140 is rotatably coupled to the bearing 136, which restrains the latch 140 against movement and against rotation except about a vertical axis. Thus, the latch 140 is rotatable about a vertical axis defined by the bearing 136.

The mechanical latching system 122 includes a coil spring 148 coupled at a rear end thereof to the third support block 134 and coupled at a front end thereof to a rear and left-hand corner of the latch 140 at a location that is rearward and leftward of the bearing 136. The coil spring 148 is in tension and biases the latch 140 to rotate about the bearing 136 in a clockwise direction when viewed from above. The mechanical latching system 122 also may include a stopper 150, as shown, which may be made of rubber, plastic, or other suitable material, rigidly coupled to the second support block 132. The stopper 150 is stationary and is positioned to engage with the latch 140 at a front and left-hand corner thereof at a location that is forward and leftward of the bearing 136, and to exert a force against the latch 140 preventing rotation of the latch 140 in a clockwise direction when viewed from above when the latch 140 is in contact with and engaged with the stopper 150.

A rear end of the rod 138 is rotatably coupled to a right end of a linkage bar 152 at a hinge 154, and a left end of the linkage bar 152 is rigidly coupled to a rear and right-hand corner of the latch 140 at a location that is rearward and rightward of the bearing 136. Thus, when a rearward force is exerted against a front end of the rod 138, the rod 138 travels rearward through the first support block 130 and causes the right end of the bar 152 to move rearward. When the right end of the bar 152 moves rearward, engagement of the bar 152 with the latch 140 causes the latch 140 to rotate counter-clockwise when viewed from above about the vertical axis defined by the bearing 136. When the latch 140 rotates counter-clockwise in this manner, the latch 140 separates and moves radially away from the stopper 150 and the spring 148 is stretched such that the tension in the spring 148 increases. When the rearward force is no longer exerted against the front end of the rod 138, tension in the spring 148 pulls on the latch 140 and causes the latch 140 to rotate clockwise when viewed from above until the latch 140 engages the stopper 150, and the rod 138 moves forward and returns to its original position.

As illustrated in FIG. 3, the appliance 102 also includes a first horizontal rail 156 coupled to an inner surface of the left side wall 126 and a second horizontal rail 158 coupled to an inner surface of the right side wall 128. The first and second rails 156 and 158 each extend horizontally, parallel to one another, at the same elevation as one another, and from the front of the storage cavity 110 of the appliance 102 to the back of the storage cavity 110 of the appliance 102. A gap between a bottom surface of the rails 156, 158 and the horizontal support surface 114 of the piece of sheet metal 112 can have a vertical dimension suitable to receive one of more wheels of the rack 106 therein. The rails 156, 158 act as a guide for the moment of the rack 106 into and out of the appliance 102. The rails 156, 158 also prevent the rack from tipping laterally while retained within the appliance 102. The appliance 102 also includes a horizontal flange or plate 160 that extends horizontally outward from a front surface of the appliance 102.

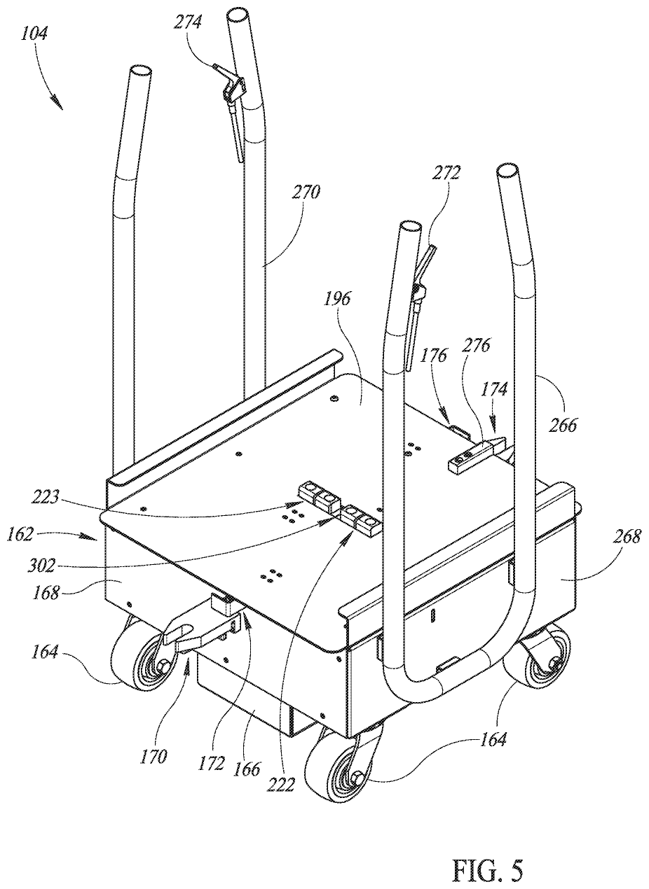

FIG. 5 illustrates the shuttle 104 isolated from the other components of the system 100. In particular, FIG. 5 illustrates that the shuttle 104 includes a main body 162 having an overall rectilinear or rectangular cuboid shape, although any shape may be used. The shuttle 104 includes four caster wheels 164 and an enclosure or housing 166 coupled to a bottom end surface of the main body 162. The four caster wheels 164 can allow the shuttle 104 to be pushed, pulled, driven, or otherwise moved about its local environment in a variety of directions. The housing 166 can house a weight, such as a block of concrete, batteries, or metal such as steel or iron, to lower the center of gravity of the shuttle 104 to reduce the chance that the shuttle 104 and/or the rack 106 might tip over. The housing 166 can also house electronic and/or mechanical components such as an electric motor, a control system to facilitate automated driving of the shuttle 104, batteries, radios, and other electronic components.

A front end surface 168 of the main body 162 of the shuttle 104 includes a front end latching system 170 and a front end actuator 172. In an embodiment, in addition to causing the raising and lowering of the release block 222 (described below), the front end actuator 172 may generate a signal indicating when the shuttle 104 is engaged and/or disengaged with the appliance 102. The signal may be generated in the appliance 102 through contact with the front end actuator 172 or in the shuttle 104 or both.

Except where otherwise stated or illustrated herein, the shuttle 104 can be rotationally symmetric about a vertical central longitudinal axis of the shuttle 104 such that, for example, a rear end surface of the main body 162 of the shuttle 104 includes a rear end latching system 174 having features corresponding to those of the front end latching system 170 and a rear end actuator 176 having features corresponding to those of the front end actuator 172. Due to this symmetry, the shuttle 104 is bidirectional—the shuttle 104 can be operated in the same manner whether operated by an operator at the front or at the rear of the shuttle 104, whether driving forward or rearward, whether docking to the appliance 102 or other docking station at its front end or at its rear end, and whether the rack 106 is loaded onto the shuttle 104 at its front end or at its rear end. Thus, the shuttle 104 does not have a front end or a rear end in a local sense, and terms such as front and rear as used herein in connection with the shuttle 104 refer to a front and a rear of the shuttle 104 as it is oriented within the larger system 100 as shown in FIGS. 1 and 2.

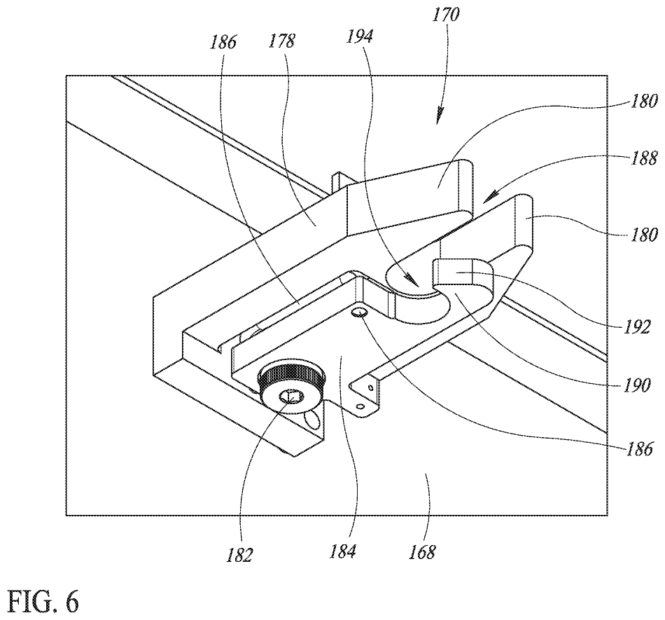

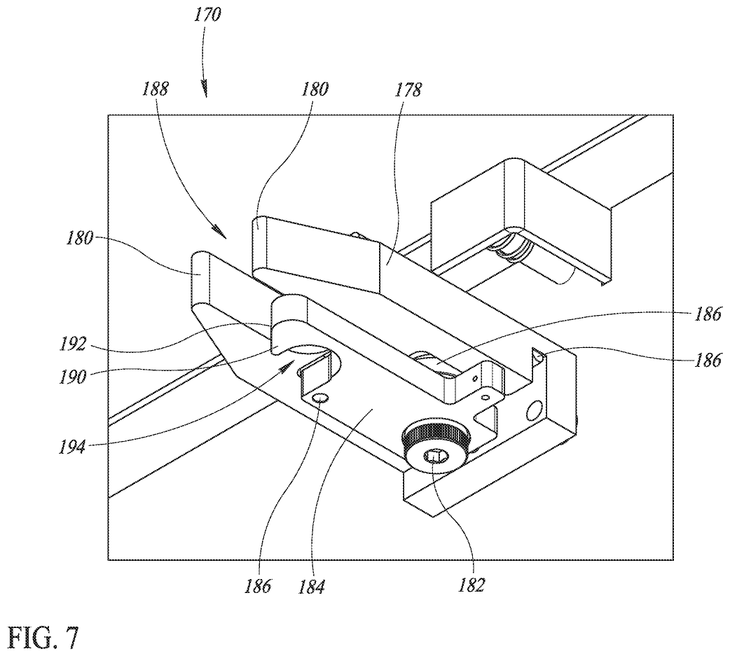

FIGS. 6 and 7 illustrate additional details of the front end latching system 170 from two different bottom perspective views. As illustrated in FIGS. 6 and 7, the front end latching system 170 includes a fork 178 having two tines 180 that extend forward from the front end surface 168 of the main body 162 of the shuttle 104. The two tines have a gap therebetween to create a slot 188 sized and dimensioned to receive a pin to be locked to the latching system 170. The fork 178 is rigidly coupled to the front end surface 168. The front end latching system 170 also includes a latch 184 located immediately below or underneath the fork 178 and a rotational bearing 182 that rotationally couples the latch 184 to the fork 178 such that the latch 184 can rotate about a vertical axis defined by the bearing 182 with respect to the fork 178 and therefore also with respect to the main body 162 and the rest of the shuttle 104.

The latching system 170 also includes a torsional coil spring 186 seated within a recess formed in the underside or bottom surface of the fork 178. The spring 186 has a first end engaged with the latch 184 and a second end engaged with the fork 178 and biases the latch 184 toward the position illustrated in FIGS. 6 and 7. The latch 184 includes a tooth 190 having a beveled leading edge 192 that extends from back-to-front and from left-to-right as it extends underneath the fork 178. The tooth 190 is separated from another portion of a body of the latch 184 by a gap or a recess 194, within which a pin of another component can be retained to prevent the other component from moving forward or rearward with respect to the shuttle 104. In the position illustrated in FIGS. 6 and 7, the tooth 190 of the latch 184 and a portion of the recess 194 are located directly below a portion of the slot 188, so that a vertically-extending pin can be retained by the latching system 170 between the tines 180 of the fork 178 and by the tooth 192 of the latch 184.

A vertically-extending pin can move into the slot 188 defined between the tines 180 of the fork 178. When the pin reaches the leading edge 192 of the latch 184, the pin can exert a force against the leading edge 192 of the latch 184 that forces the latch 184 to move counter-clockwise when viewed from above about the vertical axis defined by the bearing 182 against the force of the spring 186. In such an implementation, the tooth 192 of the latch 184 may no longer be located directly below the slot 188 or a smaller portion of the tooth 192 may be located directly below the slot 188 than in the position illustrated in FIGS. 6 and 7. The pin can then move past the tooth 192 of the latch 184 and the force exerted by the spring 186 can then bias or move the latch 184 back to the position illustrated in FIGS. 6 and 7, so that the pin is retained by the latching system 170.

FIG. 5 illustrates that the shuttle 104 includes a first, right side handle 266 coupled to a right side wall 268 of the main body 162 of the shuttle 104, and a second, left side handle 270 coupled to a left side wall of the main body 162 of the shuttle 104. Each of the handles 266 and 270 includes a section of round or tubular pipe or conduit that extends horizontally across the respective side wall of the main body 162, and vertically upward at both a front end and a rear end of the horizontal section of the conduit. The two vertical portions of each of the handles 266 and 270 form individual grips by which an operator can hold, manipulate, control, and move the shuttle 104. Although illustrated as tubular, the handles may have any cross-sectional shape at any location and may be further provided with a grip surface or shaped grip for user comfort.

For example, a human operator can hold and push or pull on the vertical portion of the handle 266 nearest the front of the shuttle 104 and the vertical portion of the handle 270 nearest the front of the shuttle 104 to move the shuttle 104 forward, rearward, or to steer the shuttle 104. Similarly, a human operator can hold and push or pull on the vertical portion of the handle 266 nearest the rear of the shuttle 104 and the vertical portion of the handle 270 nearest the rear of the shuttle 104 to move the shuttle 104 forward, rearward, or to steer the shuttle 104.

Further, the second, left side handle 270 includes a lever or switch 274 coupled to the vertical portion of the handle 270 nearest the rear of the shuttle 104. The switch 274 can be communicatively, mechanically, and/or electronically coupled to the front end latching system 170, such that an operator can manipulate, such as press or squeeze, the switch 274 to cause the front end latching system 170 to release a pin of another component held thereby, such as by causing the latch 184 to rotate counter clockwise when viewed from above with respect to the vertical axis of rotation defined by the bearing 182 against the biasing force of the spring 186. Similarly, the first, right side handle 266 includes a lever or switch 272 coupled to the vertical portion of the handle 266 nearest the front of the shuttle 104. The switch 272 can be communicatively, mechanically, and/or electronically coupled to the rear end latching system 174, such that an operator can manipulate, such as press or squeeze, the switch 272 to cause the rear end latching system 174 to release a pin of another component held thereby, such as in the same manner described above for the switch 274 and the front end latching system 170.

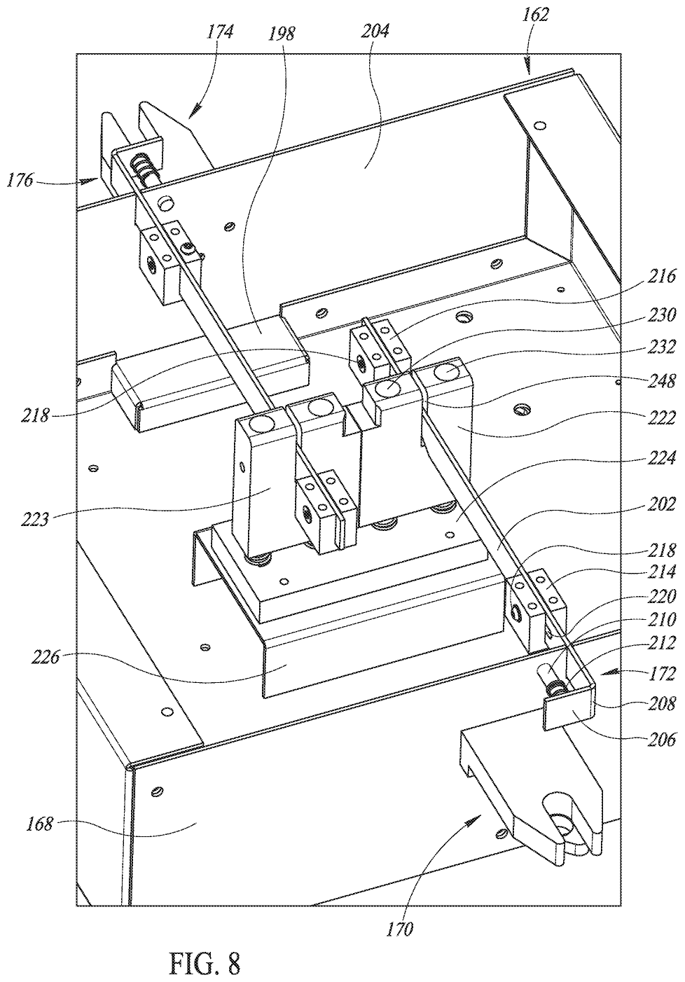

FIG. 8 illustrates a portion of the main body 162 of the shuttle 104 with a cover 196 of the main body 162 (see FIG. 5) removed to illustrate internal components of the shuttle 104. As illustrated in FIG. 8, the main body 162 of the shuttle 104 includes an internal enclosure or housing 198 having an opening 200 at a rear end thereof and in the rear end wall 204 of the main body 162 of the shuttle 104 (see FIG. 2). The housing 198 and the opening 200 are sized, positioned, oriented, and dimensioned to receive and accommodate, or mate with, the horizontal flange or plate 160 that extends horizontally outward from the front surface of the appliance 102. The main body 162 of the shuttle 104 can also include an internal enclosure or housing similar to the housing 198 and an opening similar to the opening 200 at a front end thereof and in the front end surface 168. The housing and the opening at the front end of the main body 162 of the shuttle 104 can be sized, positioned, oriented, and dimensioned to receive and accommodate, or mate with, the horizontal flange or plate 160 that extends horizontally outward from the front surface of the appliance 102.

As also illustrated in FIG. 8, the front end actuator 172 includes an L-shaped strip of sheet metal or other material 202 that extends front-to-back within the interior of the main body 162 of the shuttle 104. A portion of strip of sheet metal 202 is engageable from an exterior of the main body 162 of the shuttle 104. For example, a portion of strip of sheet metal 202 may extend through a front end surface 168 of the main body 162 of the shuttle 104 so that a front end of the strip of sheet metal 202 is visible and physically engageable from the front of the enclosed shuttle 104. A front end portion 206 of the strip of sheet metal 202 is angled at a ninety degree corner 208 with respect to the rest of the strip of sheet metal 202, and extends from side-to-side across the front end surface 168 of the main body 162 of the shuttle 104. In an alternative embodiment, the unitary strip of sheet metal 202 may be replaced by several components connected together in order to position the front end actuator 172 in the appropriate location. Alternatively, a pair of magnets or a magnet and a piece of ferrous metal may be employed to engage the portion of strip of sheet metal 202 magnetically, in which case the portion of strip of sheet metal 202 may be fully housed within the main body 162 of the shuttle 104. The front end actuator 172 also includes a peg 210 extending front-to-back from a rearward-facing surface of the front end portion 206 of the strip of sheet metal 202 to the front end surface 168 of the main body 162 of the shuttle 104, as well as a coil spring 212 positioned on and coiled about the peg 210. The coil spring 212 can have a first end engaged with the front end surface 168 of the main body 162 of the shuttle 104 and a second end engaged with a rear surface of the front end portion 206 of the strip of sheet metal 202, such that the spring 212 biases the front end portion 206 and the strip of sheet metal 202 forward with respect to the rest of the main body 162 of the shuttle 104.

As also illustrated in FIG. 8, the front end actuator 172 also includes a first support block 214 and a second support block 216, each of the support blocks 214, 216 rigidly coupled, such as by mechanical fasteners such as bolts, screws, etc., or by adhesives such as glues, epoxies, etc., to an underside or bottom surface of the cover 196 of the main body 162 of the shuttle 104. Each of the support blocks 214, 216 includes a slot formed in its upper surface that extends up-and-down and front-to-back through the support block 214, 216, but that does not extend all the way to the bottom surface of the support block 214, 216. The slots are sized and dimensioned to receive a portion of the strip of sheet metal 202 therein. Each of the support blocks 214, 216 also includes a screw, bolt, pin, peg, or other similar structure 218 that extends side-to-side through the support block 214, 216, and through the slot formed therein.

The strip of sheet metal 202 includes two slots 220 extending through the thickness of the sheet metal 202 and front-to-back along a length of the strip of sheet metal 202. Each of the two slots 220 is positioned to at least partially overlap with a respective one of the slots formed in the first and second support blocks 214, 216, such that each of the pins 218 extends through a respective one of the slots 220. The engagement of the strip of sheet metal 202 within the slots formed in the support blocks, and of the pins 218 within the slots 220 formed in the strip of sheet metal, restrains the strip of sheet metal 202 against motion other within a limited range of motion front-to-back with respect to the main body 162 of the shuttle 104.

As also illustrated in FIG. 8, the front end actuator 172 also includes a release block 222 coupled to a support plate 224, the support plate 224 coupled to a support flange 226, the support flange 226 coupled to an upper surface of a plate at a bottom end of the main body 162. The release block 222 can be made of any suitable material such as polyoxymethylene, which is commercially available under the brand name Delrin™, among others. The release block 222 is positioned between the first and second support blocks 214, 216 and includes a slot 228 formed in its upper surface that extends up-and-down and front-to-back through the release block 222. The slot 228 is sized and dimensioned to receive a portion of the strip of sheet metal 202 therein. The release block 222 also includes a first cylindrical conduit 230 and a second cylindrical conduit 232 extending vertically from a top end of the release block 222 to a bottom end of the release block 222. The first and second conduits 230, 232 are positioned on either side of the slot 228 with respect to one another.

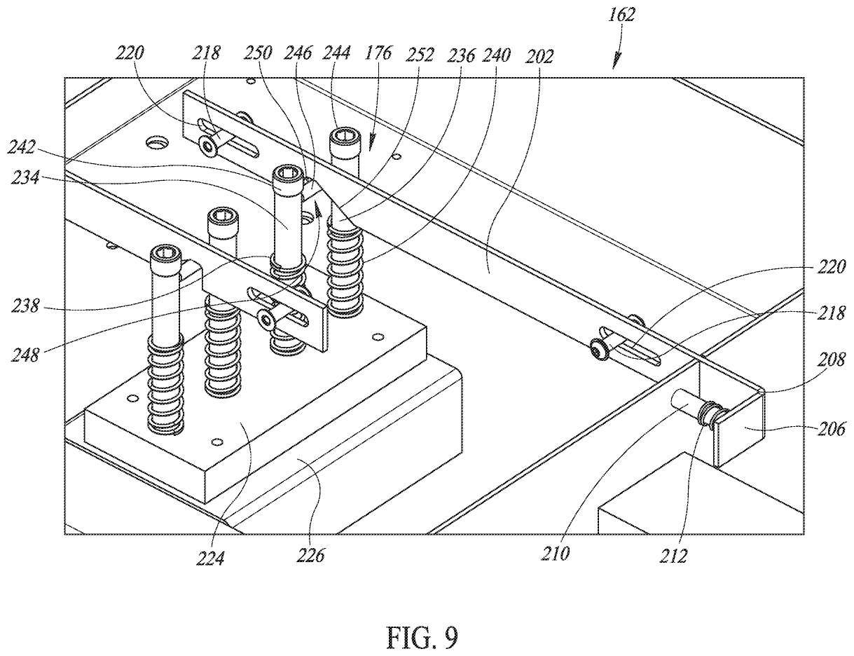

FIG. 9 illustrates another view of the components of the shuttle 104 illustrated in FIG. 8, with the support blocks 214, 216, and the release block 222 removed to illustrate additional features. For example, FIG. 9 illustrates the pins 218 and the slots 220. FIG. 9 further illustrates that the front end actuator 172 also includes a first rod 234 and a second rod 236, the two rods 234 and 236 coupled to the support plate 224 and extending vertically upward from the support plate 224. The two rods 234 and 236 are positioned, dimensioned, and otherwise configured to extend through the first and second conduits 230, 232, respectively, such that the release block 222 can slide or ride up-and-down along the rods 234 and 236.

FIG. 9 also illustrates that the front end actuator 172 includes a first coil spring 238 coupled to and extending around the first rod 234 and a second coil spring 240 coupled to and extending around the second rod 236. Respective first, bottom ends of the springs 238 and 240 can be engaged with the support plate 224, and respective second, top ends of the springs 238 and 240 can be engaged within internal features within the conduits 230 and 232, such that the springs 238 and 240 bias the release block 222 upward away from the support plate 224. The front end actuator 172 also includes a first end cap 242 coupled to the top end of the first rod 234 and a second end cap 244 coupled to the top end of the second rod 236. The end caps 242, 244 have larger diameters than their respective rods 234, 236, and engage with internal features within the conduits 230 and 232, such that the end caps 242, 244 limit the upward movement of the release block 222 along the rods 234 and 236.

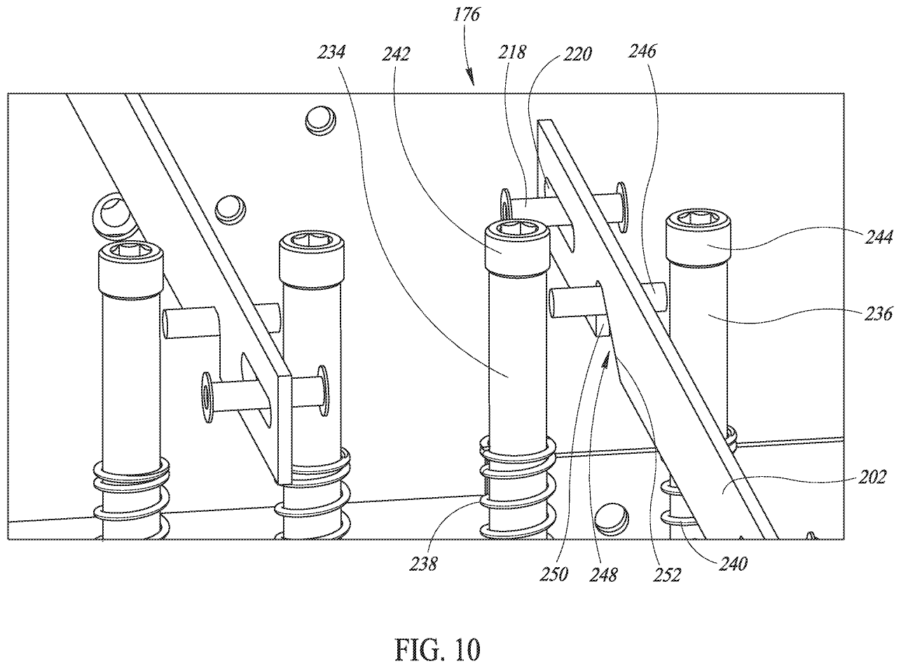

FIG. 10 illustrates another perspective of the front end actuator 172, including one of the pins 218 and one of the slots 220, the two rods 234, 236, the two springs 238, 240, and the two end caps 242, 244. FIG. 10 also illustrates that the front end actuator 172 also includes a driving pin 246 situated between and extending side-to-side between the first and second rods 234, 236, and which is not directly coupled to, and separated by a gap from the first and second rods 234, 236. FIGS. 9 and 10 together illustrate that the strip of sheet metal 202 includes a groove or a notch 248 formed in a bottom surface thereof and that the driving pin 246 extends through the notch 248. The notch 248 has a vertical rear end 250 that extends upward from the bottom surface of the strip of sheet metal 202 to a top end thereof and a sloped front end 252 that extends downward and forward from a corner at a top end of the vertical rear end 250 forward and downward to the bottom surface of the strip of sheet metal 202.

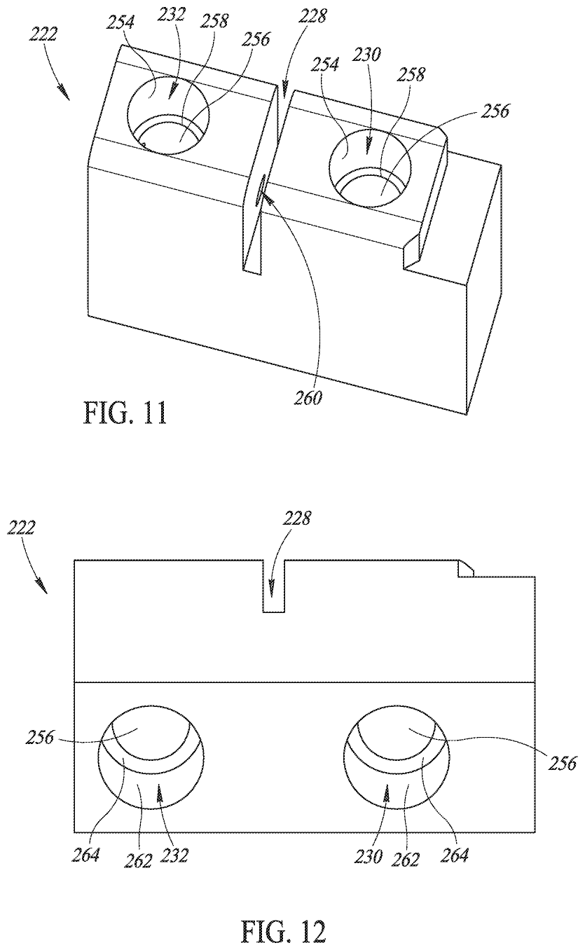

FIG. 11 illustrates the release block 222 separated from the other components of the shuttle 104. As illustrated in FIG. 11, the conduits 230, 232 extending through the release block 222 each include a respective narrow portion 256 at a middle portion thereof and a respective relatively wider portion 254 at an upper or top end portion thereof, thereby creating a respective lip or a shoulder 258 extending radially outward from a top end of the respective narrow portion 256 to a bottom end of the respective relatively wider portion 254. In operation, corresponding lips or shoulders formed by undersides or bottom surfaces of the endcaps 242 and 244 can engage with the shoulders 258 to limit upward motion of the release block 222.

As also illustrated in FIG. 11, the release block 222 includes a conduit 260 that extends side-to-side through the release block 222, from one side of the slot 228 to the other side of the slot 228. In operation, the driving pin 246 is positioned within the conduit 260 and extends from within the release block 222 on a first side of the slot 228, through the slot, to within the release block 222 on a second side of the slot 228 opposite to the first side. Because the driving pin 246 is positioned within the conduit 260, the driving pin 246 is restrained against front-to-back and up-and-down movement with respect to the release block 222. Further, the engagement of the release block 222 with the first and second rods 234, 236 restrains the release block 222 against front-to-back and side-to-side movement with respect to the rest of the main body 162 of the shuttle 104.

FIG. 12 illustrates the release block 222 separated from the other components of the shuttle 104. As illustrated in FIG. 12, the conduits 230, 232 extending through the release block 222 each include the respective narrow portion 256 at a middle portion thereof and a respective relatively wider portion 262 at a lower or bottom end portion thereof, thereby creating a respective lip or a shoulder 264 extending radially outward from a bottom end of the respective narrow portion 256 to a top end of the respective relatively wider portion 262. In operation, top ends of the springs 238 and 240 can engage with the shoulders 264 to bias the release block 222 upwards.

When a rearward force is exerted against a front end of the strip of sheet metal 202, such as against the front end portion 206 thereof, the strip of sheet metal 202 travels rearward through the front end surface of the main body 162 and through the slots formed in the first and second support blocks 214, 216, including against the biasing action of the spring 212. Because the strip of sheet metal 202 is restrained against vertical motion with respect to the rest of the main body 162, because the driving pin 246 is restrained against front-to-back movement with respect to the release block 222 and the release block 222 is restrained against front-to-back movement with respect to the rest of the main body 162, and because the driving pin 246 is engaged with the sloped front end 252 of the notch 248 formed in the strip of sheet metal 202, as the strip of sheet metal 202 travels rearward, the sloped front end 252 of the notch 248 pushes the driving pin 246 downward with respect to the rest of the main body 162. Because the driving pin 246 is restrained against up-and-down movement with respect to the release block 222, as the driving pin 246 travels down with respect to the rest of the main body 162, the driving pin 246 drives the release block 222 downward with respect to the rest of the main body 162, along the rods 234 and 236, and against the biasing action of the springs 238 and 240. In some implementations, in use, the release block 222 can be driven downward such that a top end surface thereof is at the same elevation as or below an adjacent top end surface of the cover 196 (see FIG. 5). In this position, the release block 222 no longer prevents movement of a rack 106 onto or off of the shuttle 104.

When the rearward force is no longer exerted against the front end of the strip of sheet metal 202, the biasing action of the spring 212 and of the springs 238 and 240 can return the release block 222 to a relatively raised position and return the strip of sheet metal 202 to a relatively forward position. When in the raised position, if a rack 106 is on the shuttle 104 the release block 222 engages with a rack 106 preventing its fore and aft movement. While the front end actuator 172 has been described in detail herein, it will be understood that the rear end actuator 176 has the same features and operates in the same manner as the front end actuator 172, given that the shuttle 104 is generally rotationally symmetric about a vertical central longitudinal axis of the shuttle 104.

FIG. 5 illustrates that a portion of the release block 222 of the front end actuator 172 that extends above an upper surface of the cover 196 is spaced apart from a corresponding portion of the corresponding release block 223 of the rear end actuator 176 that extends above the upper surface of the cover 196. Thus, a gap 302 exists between the respective portions of the release blocks of the front and rear end actuators 172, 176 of the shuttle 104. The gap can be positioned and dimensioned to receive a pin or other feature of another component of the system 100.

FIG. 5 also illustrates that the shuttle 104 includes a guide block 276 coupled to a top surface of the cover 196. The guide block 276 can be positioned to guide the wheels of the rack 106 as the rack 106 is moved onto or off of the shuttle 104. In the illustrated implementation, the shuttle 104 includes only one guide block 276 at the rear end of the cover 196. In alternative implementations, the shuttle 104 can include four such guide blocks 276, with one pair of guide blocks 276 at the rear end of the cover 196 and another pair of guide blocks 276 at the front end of the cover 196. Each pair of guide blocks 276 can be positioned and dimensioned to guide wheels of the rack 106 as the rack 106 is moved onto or off of the shuttle 104 at either of the front end or the rear end of the shuttle 104. Each guide block 276 within a pair of guide blocks 276 can be positioned and dimensioned to guide different set of wheels of the rack 106 than the other guide block 276 of the pair of guide blocks 276.

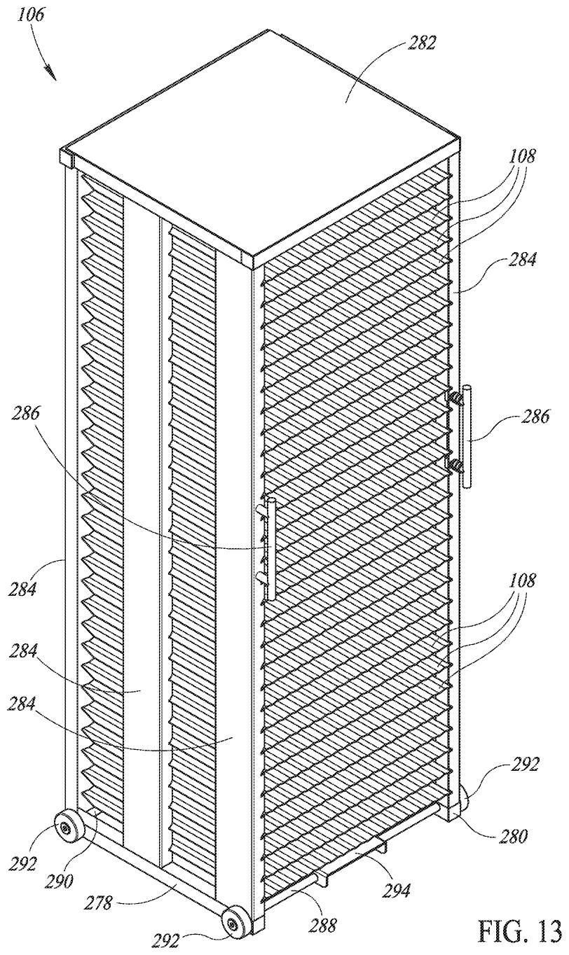

FIG. 13 illustrates a top perspective view of the rack 106 isolated from the other components of the system 100. While referred to herein as a “rack,” the rack 106 may also be referred to as a “cartridge,” “trolley,” “cassette,” or “shelving.” In particular, FIG. 13 illustrates that the rack 106 includes a first bottom rail 278 located at a first side of the rack 106, a second bottom rail 280 located at a second side of the rack 106 opposite to the first side thereof, and a top plate 282 located at a top end of the rack 106. The rack 106 also includes a plurality of posts or columns 284 that span from a top surface of one of the bottom rails 278 or 280 to a bottom surface of the top plate 282. The columns 284 or a portion thereof, such as the portion of the columns 284 to which the shelves 108 are coupled, can be made of any suitable material, such as polyoxymethylene. Together, the rails 278, 280, the top plate 282, and the columns 284 can be referred to as a “frame” of the rack 106.

The rack 106 also includes a first axle 288 extending across a width of the rack 106 at a first end of the rack 106 from the first bottom rail 278 to the second bottom rail 280. The rack 106 also includes second first axle 290 extending across the width of the rack 106 at a second end of the rack 106 opposite to the first end thereof from the first bottom rail 278 to the second bottom rail 280. The rack 106 also includes a set of four wheels 292, each of the wheels coupled to a respective end of one of the first and second axles 288, 290, and each of the wheels located outboard of, or laterally outside a footprint of, the other components of the rack 106. The rack 106 also includes a pair of removable handles 286 coupled to respective ones of the columns 284 at the first end of the rack 106. An operator can grasp the handles 286 and move and/or steer the rack 106 on its wheels 292 by pushing and/or pulling on the handles 286.

The rack 106 also includes the plurality of trays or shelves 108, on which pizzas or other food items, whether cooked, partially cooked, or uncooked, can be stored. In an embodiment, the shelves 108 can be made of stainless steel. Further, the shelves can be undulated, and have a sinusoidal wave shape when viewed from their ends, such that the pizzas or other food items rest only on the peaks of the sinusoidal wave shape. Thus, such implementations can reduce or minimize the area of contact between the food and the shelf, reduce or minimize friction between the food and the shelf, and make it easier to put the food on the shelf or pick the food up off the shelf. Such implementations can also allow moisture to be carried away from the food underneath the food through the valleys of the sinusoidal wave shape.

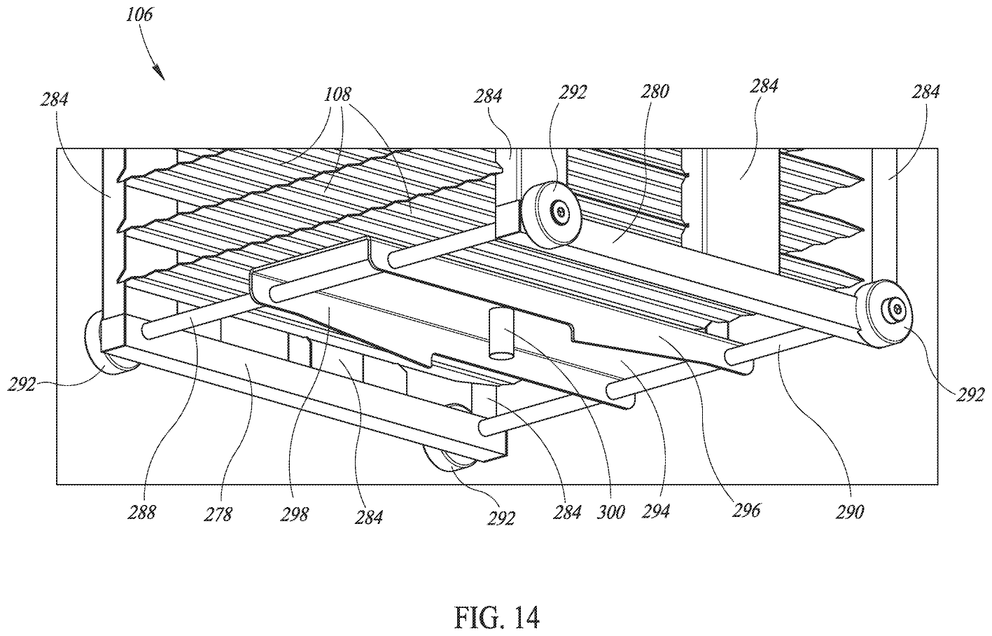

FIG. 14 illustrates a bottom perspective view of the rack 106. As illustrated in FIG. 14, the rack 106 includes a piece of sheet metal 294 supported by the axles 288 and 290. The piece of sheet metal 294 includes a first flange 296 and a second flange 298, each of the flanges 296, 298 extending downward and from the first end of the rack 106 to the second end of the rack 106. The first flange 296 includes a first portion of constant height extending from the first axle 288 to approximately the midpoint of a length of the flange 296 between the first axle 188 and the second axle 290, where the flange 296 has a step change in its height and extends further below its first portion of constant height. From the step change in its height, a height of the flange 296 tapers from the approximate midpoint of the flange 296 toward the second axle 290, where the flange 296 has a height approximating the height of its first portion of constant height. Although illustrated as formed from a single piece of sheet metal 294, this is but one example of how the flanges 296 and 298 can implemented on the base of the rack 106. In alternative embodiments, each of the flanges 296 and 298 may be separate components or, indeed, multiple components of the same or different material that work together to perform the same or similar functions as the flanges 296 and 298 as illustrated.

Similarly, the second flange 298 includes a first portion of constant height extending from the second axle 290 to approximately the midpoint of a length of the flange 298 between the first axle 188 and the second axle 290, where the flange 298 has a step change in its height and extends further below its first portion of constant height. From the step change in its height, a height of the flange 298 tapers from the approximate midpoint of the flange 298 toward the first axle 288, where the flange 298 has a height approximating the height of its first portion of constant height. Thus, the piece of sheet metal 294 can be rotationally symmetric about a vertical central longitudinal axis of the rack 106, and the rack 106 can be loaded onto the shuttle 104 as described elsewhere herein bi-directionally—either front end first, rear end first, first end first, or second end first.

FIG. 14 also illustrates that the rack 106 includes a pin 300 extending downward from an underside or bottom surface of the folded piece of sheet metal 294 at a center thereof between the first and second ends of the rack 106 and at a center thereof between the first and second sides of the rack 106. The pin 300 is sized and dimensioned to fit, such as to fit snugly, within the gap 302 between the release blocks of the front and rear end actuators 172 and 176 of the shuttle 104.

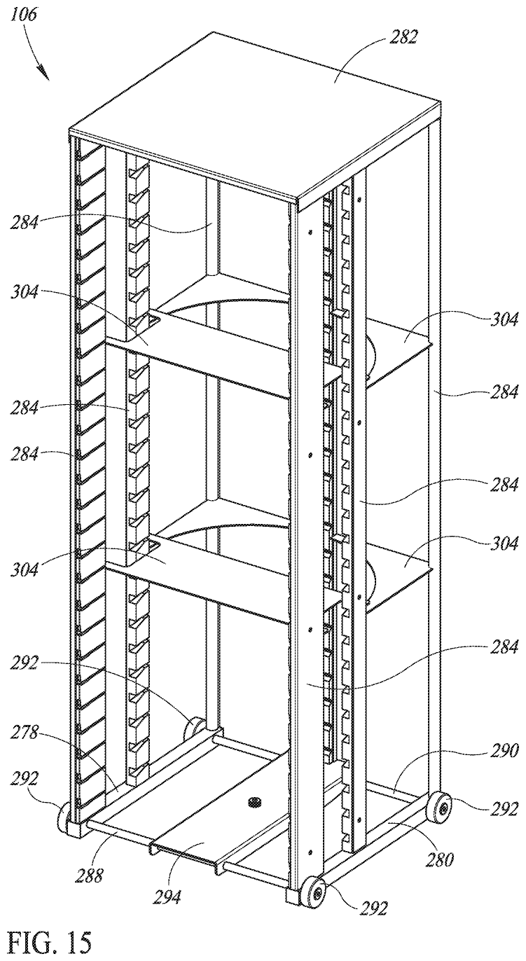

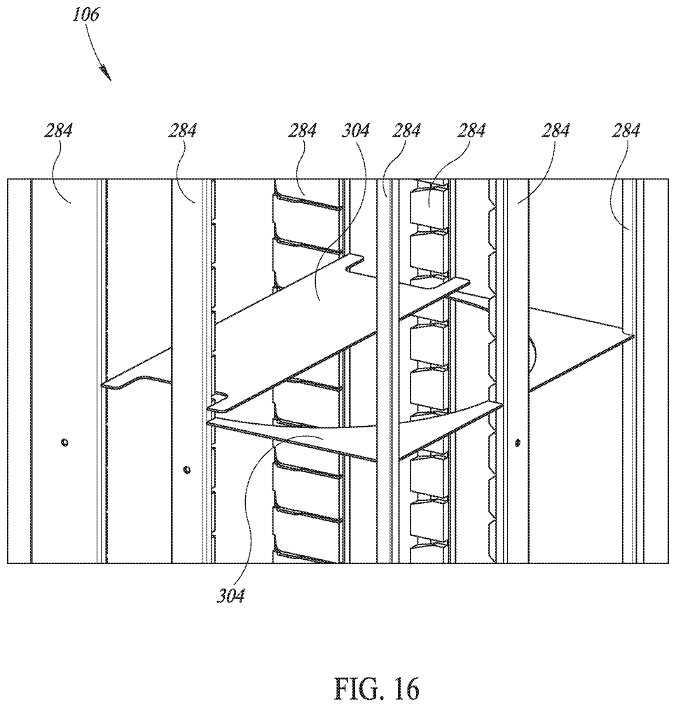

FIG. 15 illustrates another implementation of the rack 106 without the shelves 108, and FIG. 16 illustrates a close-up view of a portion thereof. As illustrated in FIGS. 15 and 16, the rack 106 can include a plurality of stiffening plates 304. The stiffening plates 304 can extend parallel to the top plate 282 and can be coupled to a plurality of the columns 284 to increase an overall stiffness or rigidity of the rack 106 and reduce the chance that the rack 106 collapses or tips over under the weight of food held thereon. As illustrated in FIGS. 15 and 16, the stiffening plates 304 can be rectangular or can be rectangular with a semi-circular portion thereof removed, such as to allow a food item such as a pizza to fit onto the shelves 108 and be cradled within the semi-circular cutout portion of the stiffening plate 304.

In some implementations, the rack 106 can include human-readable symbols (e.g., letters and numbers) or machine-readable symbols (e.g., barcodes) that uniquely identify the rack 106 within a larger collection of racks 106. Machine readable symbol readers can be provided within a local environment of the rack 106 to allow an operator to scan and thereby uniquely identify the rack 106 within the collection of racks 106. For example, a machine readable symbol reader can be coupled to the appliance 102, to the shuttle 104, and/or to a robotic arm such as described elsewhere herein to provide an operator with convenient access to the machine symbol reader to read a machine readable symbol on the rack 106.

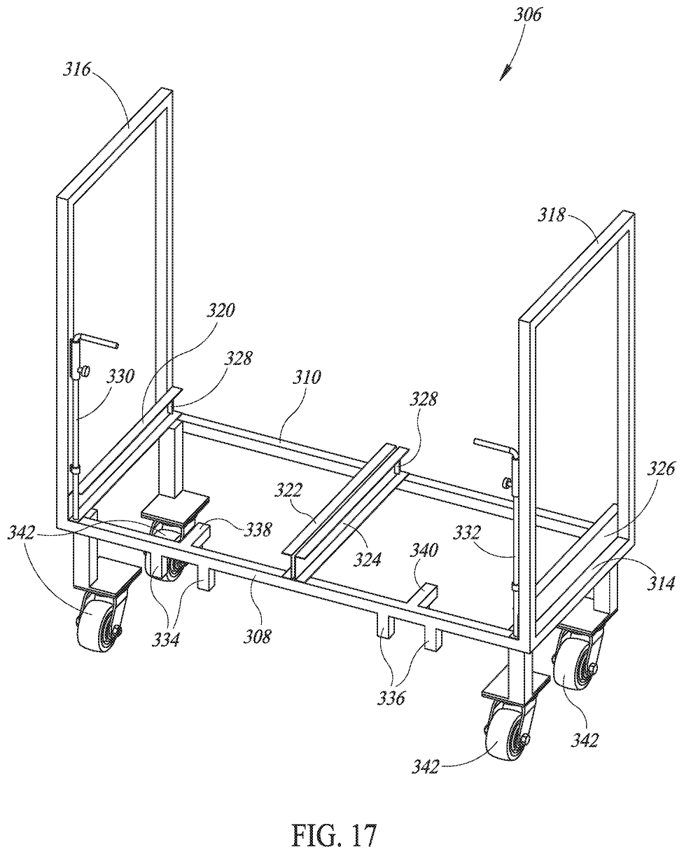

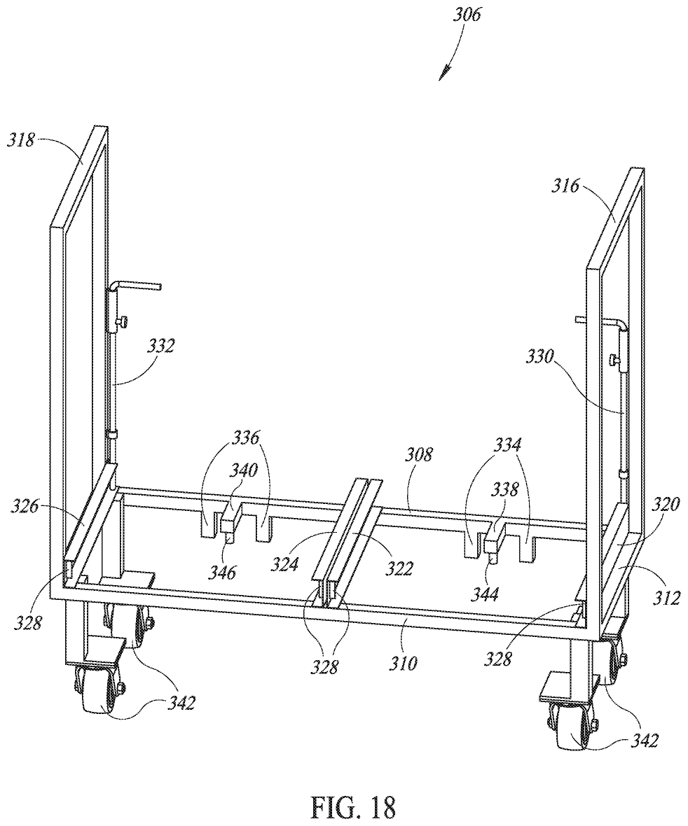

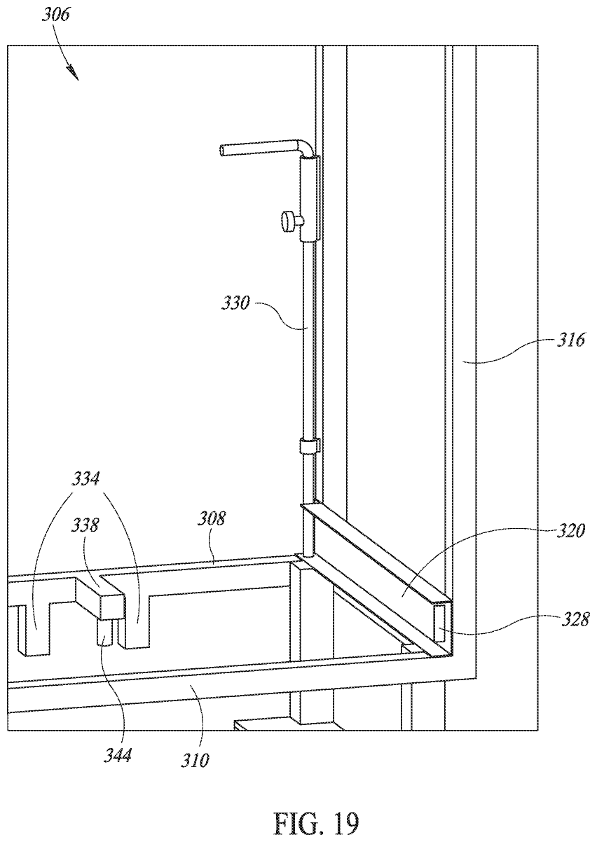

FIGS. 17-19 illustrate a front perspective view, a rear perspective view, and an enlarged perspective view of a frame 306 that can store, carry, organize, and/or transport two of the racks 106. As illustrated in FIGS. 17 and 18, the frame 306 includes a front end shaft 308 that extends side-to-side across a front end of the frame 306, a rear end shaft 310 that extends side-to-side across a rear end of the frame 306, a left side shaft 312 that extends front-to-back across a left side of the frame 306 from the front end shaft 308 to the rear end shaft 310, and a right side shaft 314 that extends front-to-back across a right side of the frame 306 from the front end shaft 308 to the rear end shaft 310.

The frame 306 also includes a left side handle 316 coupled to a front corner of the frame 306 where the front end shaft 308 meets the left side shaft 312 and to a rear corner of the frame 306 where the rear end shaft 310 meets the left side shaft 312, as well as a right side handle 318 coupled to a front corner of the frame 306 where the front end shaft 308 meets the right side shaft 314 and to a rear corner of the frame 306 where the rear end shaft 310 meets the right side shaft 314. The frame 306 also includes a left side outer rail 320 that extends adjacent to and along the left side shaft 312, a left side inner rail 322 that extends front-to-back from approximately a center of the front end shaft 308 to approximately a center of the rear end shaft 310, a right side inner rail 324 that extends adjacent to the left side inner rail 322 front-to-back from approximately a center of the front end shaft 308 to approximately a center of the rear end shaft 310, and a right side outer rail 326 that extends adjacent to and along the right side shaft 314.

Each of the rails 320, 322, 324, and 326 can comprise a steel channel section having two horizontally-oriented flanges spaced apart from one another by a distance configured to allow the wheels 292 of the rack 106 to fit between the flanges. The left side outer rail 320 can be oriented with its flanges pointing toward the left side inner rail 322, and the left side inner rail 322 can be oriented with its flanges pointing toward the left side outer rail 320, so that the wheels 292 of a first side of a rack 106 can fit between the flanges of the left side outer rail 320 and the wheels 292 of a second side of a rack 106 can fit between the flanges of the left side inner rail 322. Similarly, the right side outer rail 326 can be oriented with its flanges pointing toward the right side inner rail 324, and the right side inner rail 324 can be oriented with its flanges pointing toward the right side outer rail 326, so that the wheels 292 of a first side of a rack 106 can fit between the flanges of the right side outer rail 326 and the wheels 292 of a second side of a rack 106 can fit between the flanges of the right side inner rail 324.

The frame 306 also includes a blocking device to prevent the rack 106 from exiting the back of the frame. In the embodiment shown, the blocking device consists of blocking flanges 328 coupled at a rear end of the web of each of the channel sections of the rails 320, 322, 324, and 326 that extend outward from the respective web portion between the respective flange portions of the channel sections of the rails 320, 322, 324, and 326. The blocking flanges 328 can prevent the wheels 292 of a rack 106 from rolling off the back end of the frame 306 and its rails 320, 322, 324, and 326. In an alternative embodiment, the blocking device may be anything that prevents the rack 106 from exiting the back of the frame, including a bar between the left side handle 316 and the right side handle 318 at the back of the frame 306.

The frame 306 also includes a left side locking pin 330 that can be raised to open an entry for the wheels 292 of the rack 106 into the rail 320, and that can be lowered to block the entry for the wheels 292 of the rack 106 into the rail 320, as well as a right side locking pin 332 that can be raised to open an entry for the wheels 292 of the rack 106 into the rail 326, and that can be lowered to block the entry for the wheels 292 of the rack 106 into the rail 326. The locking pins 330 and 332 can be raised to allow an operator to load one or two racks 106 onto the frame 306, and then lowered to prevent the wheels 292 of a rack 106 from rolling off the front end of the frame 306 and its rails 320, 322, 324, and 326.

The frame 306 includes a first pair of guide bars 334 that extend downward from a bottom surface of the front end shaft 308 and a first support bar 338 that extends rearward from a rear surface of the front end shaft 308 at a location midway between the guide bars 334, where the first pair of guide bars 334 and the first support bar 338 are collectively centered side-to-side between the left side outer rail 320 and the left side inner rail 322. Similarly, the frame 306 also includes a second pair of guide bars 336 that extend downward from a bottom surface of the front end shaft 308 and a second support bar 340 that extends rearward from a rear surface of the front end shaft 308 at a location midway between the guide bars 336, where the second pair of guide bars 336 and the second support bar 340 are collectively centered side-to-side between the right side outer rail 326 and the right side inner rail 324.

As illustrated in FIGS. 17 and 18, the entire frame 306 is supported on a set of four wheels 342 which may be caster wheels as shown or any other appropriate wheel or tread design. In the embodiment shown, each of the caster wheels coupled to the rest of the frame 306 at a location directly below a front or a rear end of either the left side outer rail 320 or the right side outer rail 326. As illustrated in FIG. 18, the frame 306 also includes a first pin 344 extending vertically downward from a rear end and bottom surface of the first support bar 338 and a second pin 346 extending vertically downward from a rear end and bottom surface of the second support bar 340. The first and second pins 344, 346 can be positioned, sized, and otherwise configured to be received by either the front end latching system 170 or the rear end latching system 174 of the shuttle 104.

To operate the system 100, an operator can position one or more of the racks 106 proximate the terminal end of a food item assembly line, such as on one or more of the frames 306, and load a plurality of the shelves 108 onto the racks 106. Food items coming out the terminal end of the food item assembly line can be loaded onto the shelves 108 of the racks 106, such as by the food-item transfer system 400 and associated techniques and processes described below.

Once loading of one of the racks 106 is completed, such as when the loaded rack 106 is full of food items, a shuttle 104 can be moved toward the frame 306 and docked with the frame 306 in front of the loaded rack 106. To dock the shuttle 104 to the frame 306, the front end latching system 170 of the shuttle 104 is guided either between the first pair of guide bars 334 or between the second pair of guide bars 336 until the first pin 344 or the second pin 346, respectively, comes into contact with the leading edge 192 of the latching system 170. The shuttle 104 can be pushed further toward the frame 306 until the first pin 344 or the second pin 346 is restrained within the latching system 170, as described elsewhere herein. As the shuttle 104 docks with the frame 306 in this manner, a front surface of the front end shaft 308 of the frame 306 engages and presses on the front end portion 206 of the strip of sheet metal 202, pushing the strip of sheet metal 202 into the main body 162 of the shuttle 104 and thereby lowering the release block 222, as described elsewhere herein.

Once the shuttle 104 is docked to the frame 306 in this manner, a respective one of the locking pins 330, 332 of the frame 306 can be lifted upward to release the rack 106 from the frame 306. The rack 106 is then rolled on its wheels 292 from the frame 306 to the shuttle 104, until the step change in the height of the flange 298 moves across the lowered release block 222 and the step change in the height of the flange 296 comes into contact with a surface of a release block 223 of the rear end actuator 176. In such a position, the pin 300 at the bottom end of the rack 106 is positioned within the gap 302 between the release blocks 222 and 223. Once the rack 106 is loaded on the shuttle 104 in this manner, an operator can use the switch 274 to release the engagement of the latching system 170 with the pin 344 or 346 of the frame 306 and begin to move the shuttle 104 and the rack 106 loaded on the shuttle 104 away from the frame 306. In doing so, the operator removes the engagement of the front surface of the front end shaft 308 of the frame 306 with the front end portion 206 of the strip of sheet metal 202, allowing the release block 222 to return to its raised position, where it engages with the step change in the height of the flange 298 to lock the rack 106 on the shuttle 104.

The operator can then move the shuttle 104 and the rack 106 toward the appliance 102 until the flange 160 on the front of the appliance 102 fits into the opening 200 in the main body 162 of the shuttle, and dock the shuttle 104 with the appliance 102 in front of the appliance 102. To dock the shuttle 104 to the appliance 102, the rear end latching system 174 of the shuttle 104 is guided into the recess 118 in the front of the appliance 102 until the pin 120 comes into contact with the leading edge of a latch of the rear end latching system 174. The shuttle 104 can be pushed further toward the appliance 102 until the pin 120 is restrained within the latching system 174, as described elsewhere herein. As the shuttle 104 docks with the appliance 102 in this manner, the vertical engaging surface 116 of the appliance 102 engages and presses on a rear end portion of a strip of sheet metal of the rear end actuator 176, pushing the strip of sheet metal into the main body 162 of the shuttle 104 and thereby lowering the release block 223, as described elsewhere herein, thereby releasing the rack 106 from the shuttle 104. Further, as the shuttle 104 docks with the appliance 102 in this manner, the rear end wall 204 of the main body 162 of the shuttle 104 engages and presses on a front end of the rod 138 of the latching system 122 of the appliance, causing the latch 140 to rotate counter clockwise as viewed from above and open to receive the pin 300 at the bottom of the rack 106.

Once the rack 106 is docked to the appliance 102 in this manner, an operator can move the rack on its wheels from the shuttle 104 into the appliance 102. In some implementations, the appliance 102 can include one or more sensors to detect that the rack 106 is present within the appliance 102, and can include one or more communication systems to provide a signal indicating that the rack 106 is present within the appliance 102. Such sensors and/or communication systems can include one or more switches positioned on and/or coupled to the stopper 150 to indicate engagement/disengagement of the latch 140 with the stopper 150 and presence/absence of the rack 106 within the appliance 102. Once the rack 106 is positioned within the appliance 102, the pin 300 at the bottom end of the rack 106 is positioned within the latching mechanism 122. Once the rack 106 is loaded in the appliance 102 in this manner, an operator can use the switch 272 to release the engagement of the latching system 174 with the pin 120 of the appliance 102 and begin to move the shuttle 104 away from the appliance 102.

In doing so, the operator removes the engagement of the vertical engaging surface 116 of the appliance 102 with the front end portion of the strip of sheet metal of the latching system 174, allowing the release block 223 to return to its raised position. In doing so, the operator also removes the engagement of the rear end wall 204 of the main body 162 of the shuttle 104 with the front end of the rod 138 of the latching system 122 of the appliance, causing the latch 140 to rotate clockwise as viewed from above and close to restrain the pin 300 at the bottom of the rack 106 and thereby lock the rack 106 within the appliance 102. In some implementations, the appliance 102 can include one or more sensors to detect that the rack 106 is locked within the appliance 102, and can include one or more communication systems to provide a signal indicating that the rack 106 is locked within the appliance 102. Such sensors and/or communication systems can include one or more switches positioned on and/or coupled to the latch 140, such as within the recess 146, to indicate engagement/disengagement of the latch 140 with the pin 300 and presence/absence of the rack 106 in a fully loaded docking position.

Similar techniques can be used to move one or more of the racks 106 on a plurality of shuttles 104 between a plurality of food-item assembly lines, a plurality of appliances 102, a plurality of frames 306, and any other locations, facilities, or systems of interest. In some implementations, the system 100 can be used to replenish food stores of one or more food delivery vehicles such as food trucks, such as within a specialized food transfer station, or on an open roadway. For example, a rack 106 can be loaded into a food delivery vehicle using an overhead gantry crane to load the rack 106 into the vehicle through a top of the vehicle, or using a ramp to roll into the vehicle through a door in a side wall of the vehicle. Once the rack 106 is loaded onto a food delivery vehicle, the rack 106 may be positioned within a cooler or a refrigerator, as described elsewhere herein. In some implementations, an entire interior space of a food delivery truck may be refrigerated and the truck may carry only refrigerated food items such as uncooked pizzas.

While the uncooked pizzas are refrigerated within such a food delivery truck, a robotic system can transfer the uncooked pizzas from the racks 106 into smaller racks or cartridges having six, eight, ten, twelve, or sixteen shelves to hold a corresponding number of uncooked pizzas, so that a human operator is capable of carrying the fully loaded smaller cartridge. The smaller cartridges can then be transferred, such as by human or automated robotic operators, from the initial refrigerated food delivery truck into smaller delivery trucks within which the uncooked pizzas can be cooked and delivered to consumers. Once the uncooked pizzas are transferred to the smaller delivery trucks, an operator can remove the shelves and food items carried thereon from the smaller cartridges, place the food items into an oven for final cooking, and clean the shelves. The pizzas can be cooked in the oven eight or ten at a time to increase overall efficiency.

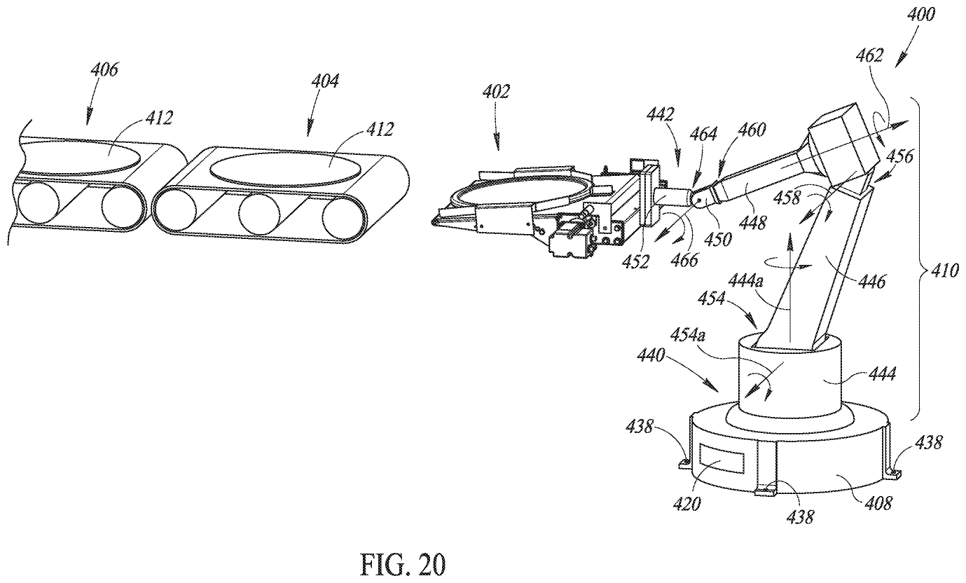

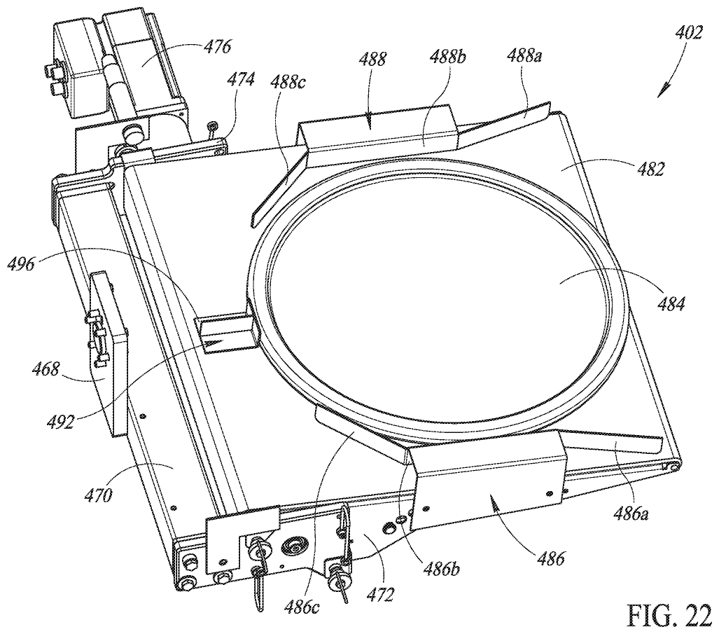

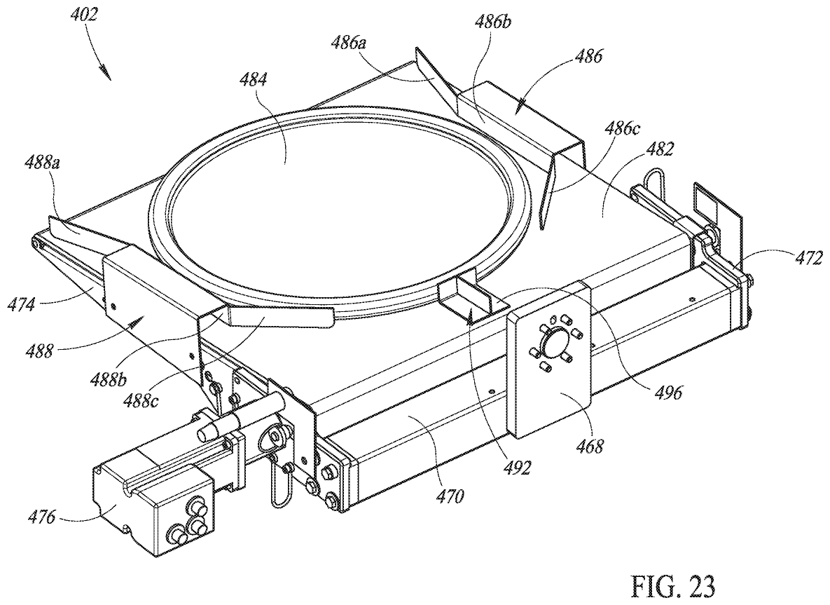

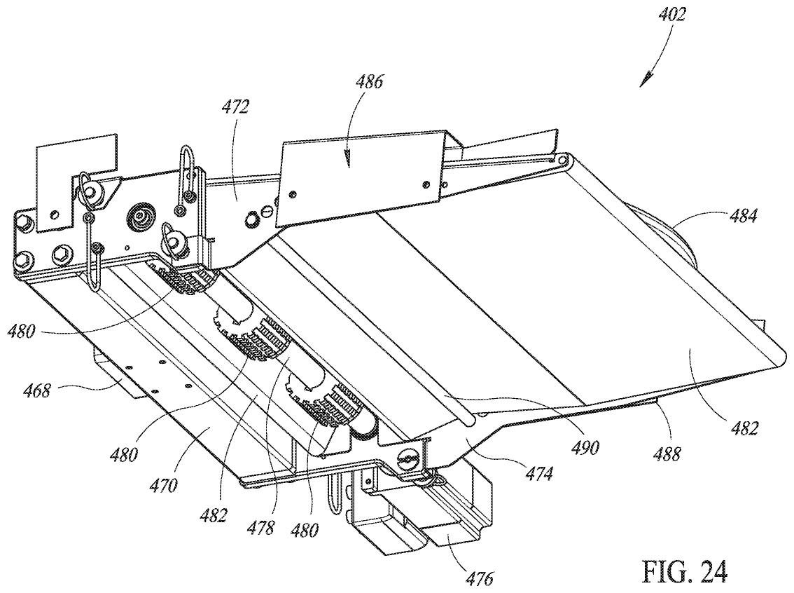

FIGS. 20-29 show a type of food-item transfer system 400 with an end-of-arm tool 402, which can be referred to herein as a conveyor 402. The conveyor 402 may be comprised of food grade material such as stainless steel or silicone rubber. In addition to the conveyor 402, the food-item transfer system 400 may include a base 408, a robotic appendage 410, and a control system 420. The conveyor 402 may be used to transfer food items such as pizzas between a conveyor belt such as a surge or intermediate conveyor belt 404 and another horizontal surface such as one of the shelves 108 of the rack 106.

The base 408 may be located proximate the floor, ground, or surface that supports the food-item transfer system 400. In some implementations, the base 408 may be weighted to increase the stability of the food-item transfer system 400 as the robotic appendage 410 translates the conveyor 402. In some implementations, the base 408 may be bolted or otherwise secured to the floor, ground, platform, or other surface, for example, by inserting bolts through one or more apertures 438. In other implementations, the base 408 may include wheels, treads or casters, and may even include a traction motor drivingly coupled to the wheels or treads to move the food-item transfer system 400 under its own power.

The robotic appendage 410 may extend from a proximal end 440 to a distal end 442. The proximal end 440 of the robotic appendage 410 may include a rotatable platform 444 that provides a vertical axis of rotation 444a for the robotic appendage 410. Such a rotatable platform 444 may be physically, rotatably coupled to the base 408. The vertical axis of rotation 444a may thereby be used to position the distal end 442 of the robotic appendage 410 with respect to the base 408. Such positioning may be used to direct the conveyor 402 to extend outward in various directions from the base 408. The rotatable platform 444 may be drivingly coupled to a motor (not shown). In some implementations, the motor may rotate the rotatable platform 444 about 360°, a plurality of times, without restriction. In some implementations, the rotation of the rotatable platform 444 may be restricted such that the rotatable platform 444 may rotate less than 360° (e.g., 180°, 90°, 45°). Such restrictions on rotation may be used, for example, to protect electrical, fluidic, or other connections that extend from the robotic appendage 410 and/or conveyor 402 to the base 408 from being damaged.

The robotic appendage 410 may include a plurality of segments, also referred to as links, such as, for example a first segment 446, a second segment 448, a third segment 450, and a fourth segment 452. The first segment 446 may be located relatively towards the proximal end 440 of the robotic appendage 410, the fourth segment 452 may be located relatively towards the distal end 442 of the robotic appendage 410, and the second segment 448 and the third segment 450 may be located therebetween. The first segment 446 may rotatably couple with the rotatable platform 444 at a first joint 454 that provides a first segment axis of rotation 454a that extends horizontally outward from the first joint 454. In some implementations, the rotation of the first segment 446 of the robotic appendage 410 about the first segment axis of rotation 454a may be controlled, for example, by one or more types of motors, such as a stepper motor, that may be used to control the location and/or the rate of rotation of the first segment 446 about the first segment axis of rotation 454a.

The second segment 448 may be rotatably coupled to the first segment 446 by a second joint 456 that provides a second segment axis of rotation 458 that extends laterally outward in a direction that is perpendicular to each of the first segment 446 and the second segment 448. The rotation of the second segment 448 of the robotic appendage 410 about the second segment axis of rotation 458 may be controlled, for example, by one or more types of motors, such as a stepper motor, that may be used to control the location and/or the rate of rotation of the second segment 448 about the second segment axis of rotation 458. The third segment 450 may be rotatably coupled to the second segment 448 via a rotatable joint 460 (e.g., a ball and socket joint) that provides a third segment axis of rotation 462 that extends outward in a direction that is parallel to a length of the second segment 448. Such a rotatable joint 460 enables the third segment 450 to rotate with respect to one end of the second segment 448. The rotation of the third segment 450 of the robotic appendage 410 may be controlled, for example, by one or more types of motors, such as a stepper motor, that may be used to control the location and/or the rate of rotation of the third segment 450 about the third segment axis of rotation 462. The fourth segment 452 may rotatably couple to the third segment 450 via a third joint 464 that provides a fourth axis of rotation 466 that extend laterally outward from the third segment 450. In some implementations, for example, the third segment 450 may be comprised of two opposing arms that extend outward from the second segment 448 and form a cavity there between that is sized and shaped to securely engage the fourth segment 452. The fourth segment 452 may thereby rotate when secured within the cavity. The rotation of the fourth segment 452 of the robotic appendage 410 may be controlled, for example, by one or more types of motors, such as a stepper motor, that may be used to control the location and/or the rate of rotation of the fourth segment 452 about the fourth segment axis of rotation 466.

In alternative implementations, the food-item transfer system 400 can include any suitable robotic appendage capable of moving the conveyor 402 around in three dimensions in its local environment in place of the robotic appendage 410. Suitable robotic appendages are widely commercially available, such as from vendors such as ABB Group.

In some implementations, the conveyor 402 may include one or more balance sensors. In such an implementation, the balance sensors may generate one or more signals that indicate a relative position, orientation, pitch, speed, velocity and/or acceleration of the conveyor 402 with respect to the surrounding environment. The balance sensors may, for example, include one or more one-axis, two-axis, three-axis accelerometers or gyroscopes, or magnetometers. In some implementations, the one or more balance sensors may be communicably coupled to the control system 420. In some implementations, the control system 420 may use one or more of the signals from the balance sensors to determine any one or more of the position, orientation, pitch, speed, velocity and/or acceleration of the conveyor 402. In some implementations, the control system 420 may use the signals received from the balance sensors to maintain the balance of a food item being transported by the conveyor 402 such that the food item does not fall from the conveyor 402. In some implementations, the control system 420 may use the signals received from the one or more balance sensors to form a closed loop control system to maintain the balance of the food item on the conveyor 402.

In some implementations, the conveyor 402 may include one or more weight sensors such as load cells. Each of the one or more weight sensors may generate a signal related to a downward force being placed upon the portion of the conveyor 402 at which the respective weight sensor is located. The weight sensors may each be communicably coupled to the control system 420. The control system 420 may determine from the signals received from the one or more weight sensors information regarding the total weight (e.g., downward force) supported by the conveyor 402, as well as the distribution of those downward forces upon the upper surface of the conveyor 402. The control system 420 may use such information regarding the downward force being applied to the upper surface of the conveyor 402 to make various determinations. For example, in some implementations, the control system 420 may use the signals received from the one or more weight sensors to determine if the conveyor 402 has fully loaded, has fully unloaded, or is in the process of loading and/or unloading one or more food items.

The control system 420 may use such information regarding the weight and/or weight distribution of food items along the upper surface of the conveyor 402 to control one or more components during the loading and/or unloading process. In some implementations, the control system 420 may move or otherwise manipulate the locations, orientation, pitch, speed, velocity, and/or acceleration of the conveyor 402 in response to determining that the one or more food items may be unevenly distributed along the upper surface of the conveyor 402. In some implementations, the control system 420 may use the signals from the one or more weight sensors to detect movement by the food items being carried by the upper surface of the conveyor 402. In such a situation, the control system 420 may control the conveyor 402 to match the normal force applied by the conveyor 402 to the food item with any other forces acting upon the food item to prevent the food item from falling off the upper surface of the conveyor 402.

In some implementations, the conveyor 402 may include one or more temperature sensors or thermocouples. Such temperature sensors or thermocouples may be used to detect a temperature of a bottom surface of a food item being transported by the conveyor 402. As such, the detected temperatures of the bottom surface of the food item may be used to determine that the food items is fully cooked, and/or to determine an additional cooking time for the food item.

In some implementations, the food-item transfer system 400 may include one or more sensors such as imagers, cameras, video cameras, frame grabbers, radar source and sensor, Lidar source and sensor, ultrasonic source and sensors, mechanical position encoders or optical position encoders such as rotary encoders, optical emitter and receivers pairs that pass a beam of light (e.g., infrared light source and sensor) across a surface, commonly referred to as an “electric eye,” ultrasonic position detectors, digital cameras, Hall effect sensors, load cells, and/or magnetic or electromagnetic radiation (e.g., infrared light)-based proximity sensors. Such sensors may provide signals indicating objects or items in the three-dimensional space surrounding the food-item transfer system 400.

Such signals may include indications, for example, of the upper surface of the conveyor 402 or some other horizontal surface. In some implementations, the sensors may detect the locations of food items being conveyed by the conveyor 402. The sensors may be communicatively coupled to the control system 420 such that the sensors may transmit such signals to the control system 420. The control system 420 may use such signals to determine actions and/or functions that various components of the food-item transfer system 400 may take. In some implementations, the control system 420 may store one or more motion plans that describe the multiple actions or motions for one or more components to take to perform a desired action (e.g., retrieve a food item from the intermediate conveyor belt 404).

In some implementations, the sensors may include one or more sensors to determine a position and/or orientation of the conveyor 402. Such sensors may include, for example, one or more rotary sensors that may be included as part of or proximate the motor that drives the rotatable platform 444. Such a sensor may be, for example, a rotary encoder that may be used to determine the orientation of the rotatable platform 444 and the attached robotic appendage 410 and conveyor 402. In some implementations, the sensors may include one or more sensors that may be used to determine the position of the conveyor 402 relative to the distal end of the robotic appendage 410.

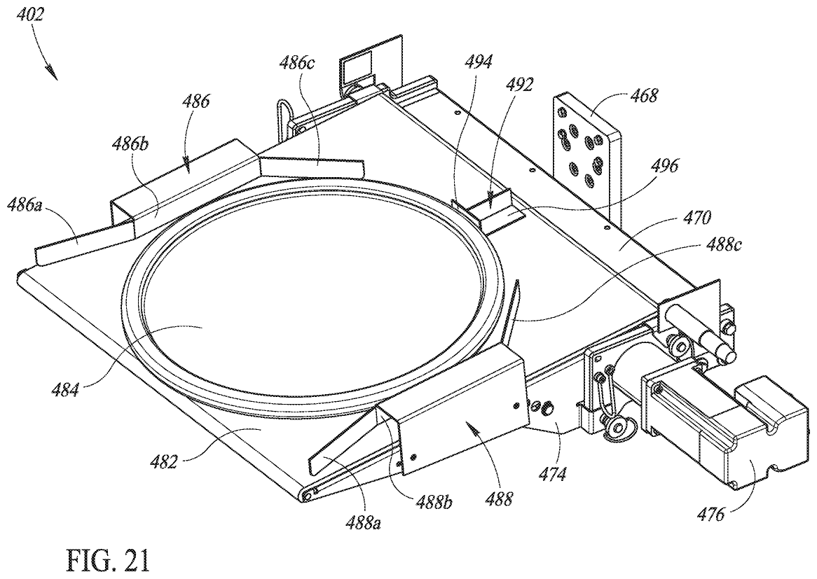

FIGS. 21-24 illustrate various perspective views of the conveyor 402 isolated from other components of the food-item transfer system 400. As illustrated in FIGS. 21-24, the conveyor 402 includes a coupling plate 468 by which the conveyor 402 may be rigidly coupled to the fourth segment 452 of the robotic appendage 410 of the food-item transfer system 400. The coupling plate 468 is rigidly coupled to a crossbar 470 that extends side-to-side across a width of the conveyor 402 from a left end thereof to a right end thereof. The crossbar 470 is rigidly coupled at its left end to a left side support rail 472 and at its right end to a right side support rail 474. The left and right side support rails 472, 474 extend front-to-back along a length of the conveyor 402 from a front end thereof to a rear end thereof.

As also illustrated in FIGS. 21-24, the conveyor 402 also includes a motor 476, such as an electric motor 476, which is mechanically coupled to an axle 478 and a plurality of grippers 480 rigidly mounted on the axle 478 such that the motor 476 can drive rotation of the axle 478 and the grippers 480. The conveyor 402 also includes a looped conveyor belt 482 which can carry and move a food item such as a pizza 484 thereon. The conveyor belt 482 can be porous or non-porous, depending on the food items being transported. The conveyor belt 482 is mounted on a series of rollers 490 that guide its path through the conveyor 402 and is engaged with the grippers 480 such that the motor 476 can drive movement of the conveyor belt 482 such that an upper surface of the conveyor belt 482 can move forward and rearward with respect to the rest of the conveyor 402.

The conveyor 402 also includes a left side guide rail 486 that is rigidly coupled to the left side support rail 472 and that extends upward therefrom and over the upper surface of the conveyor belt 482, as well as a right side guide rail 488 that is rigidly coupled to the right side support rail 474 and that extends upward therefrom and over the upper surface of the conveyor belt 482. The left and right side guide rails 486, 488 provide respective vertical guiding surfaces that can help guide a food item 484 onto the conveyor belt and toward the coupling plate 468 over the conveyor 402, as well as to center the food item on the conveyor 402 and the conveyor belt 482 as the food item moves toward the coupling plate 468.

In the illustrated implementation, each of the left and right side guide rails 486, 488 includes a leading portion 486a, 488a, nearest to an entrance for the food item onto the conveyor 402, a trailing portion 486c, 488c, opposite to the leading portion 486a, 488a, and an intermediate portion 486b, 488b, between the respective leading and trailing portions. The leading portions 486a, 488a extend toward one another as they extend from the entrance for the food item onto the conveyor 402 toward the coupling plate 468, the intermediate portions 486b, 488b extend parallel to one another as they extend toward the coupling plate 468, and the trailing portions 486c, 488c extend toward one another as they extend from the entrance for the food item onto the conveyor 402 toward the coupling plate 468.

The conveyor 402 also includes a push bar 492 rigidly coupled to an upper surface of the conveyor belt 482. The push bar 492 includes a forward face 494 at a first end thereof nearest to the entrance for the food item onto the conveyor 402 and farthest from the coupling plate 468 and that faces toward the entrance for the food item onto the conveyor 402 and away from the coupling plate 468. The forward face 494 may be substantially perpendicular to the upper surface of the conveyor belt 482. The forward face 494 of the push bar 492 may have a flat or an arcuate profile (e.g., a portion of a circle, portion of an oval), which may advantageously substantially match a shape of a food item, for instance a periphery of a crust of a round pizza pie. The push bar 492 also includes a coupling portion 496 at a second end thereof opposite the first end, farthest from the entrance for the food item onto the conveyor 402 and nearest to the coupling plate 468. The push bar 492 may be coupled to the upper surface of the conveyor belt 482 only at its coupling portion 496.

The push bar 492 may help to push food items such as the pizza 484 off of the conveyor 402. For example, the motor 476 can be operated to move the upper surface of the conveyor belt 482 to begin moving the food item off of the conveyor 402, such as onto a shelf 108 of the rack 106. As the upper surface of the conveyor belt 482 moves in this manner, the push bar 492 can engage with a trailing edge of the food item to ensure the food item moves along with the conveyor belt 482. Once the food item is completely off of the conveyor belt 482, the push bar 492 will continue to engage with and push against the trailing edge of the food item, to push the food item even further away from the rest of the conveyor and even further onto the shelf 108 of the rack 106. In particular, because the push bar 492 is only coupled to the upper surface of the conveyor belt 482 at the coupling portion 496 thereof, the forward face 494 of the push bar 492 can be separated and extend away from the conveyor belt 482 to push the food item further away from the rest of the conveyor 402 and further onto a shelf 108 of the rack 106 than the conveyor belt 482 could achieve by itself without the push bar 492.

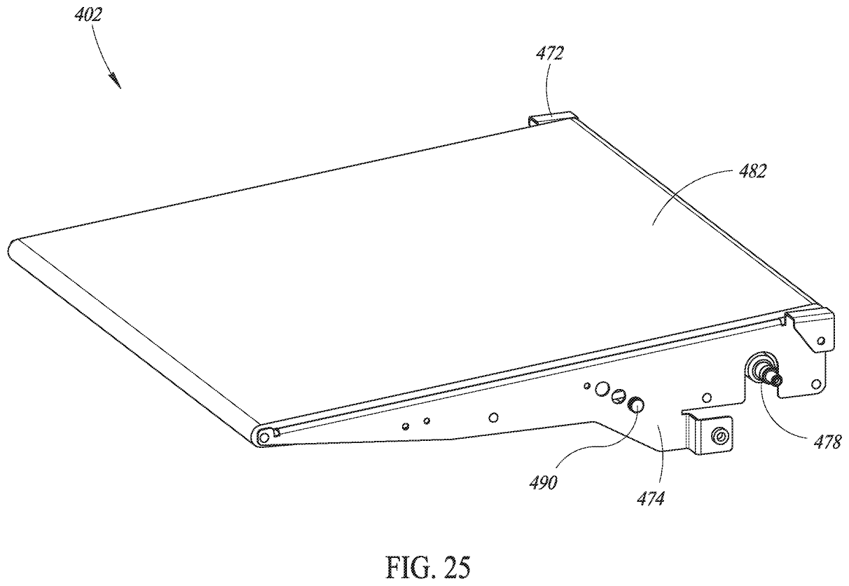

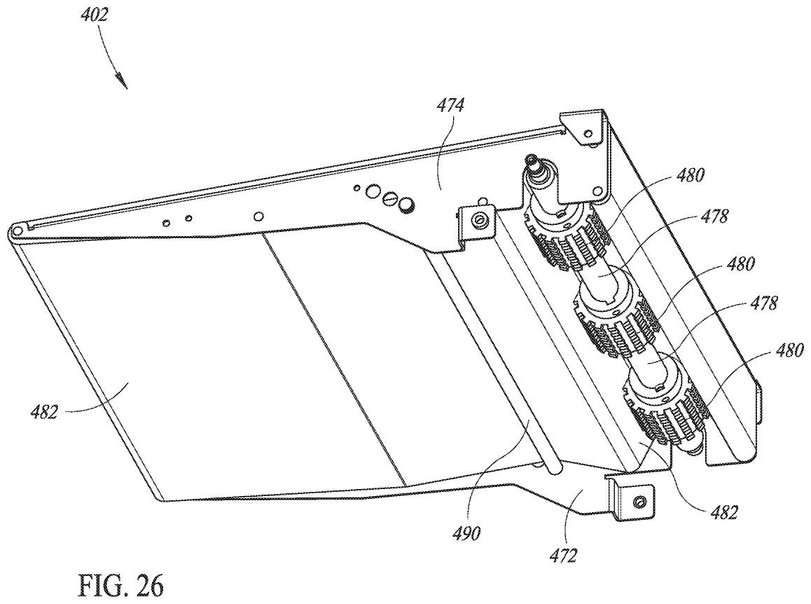

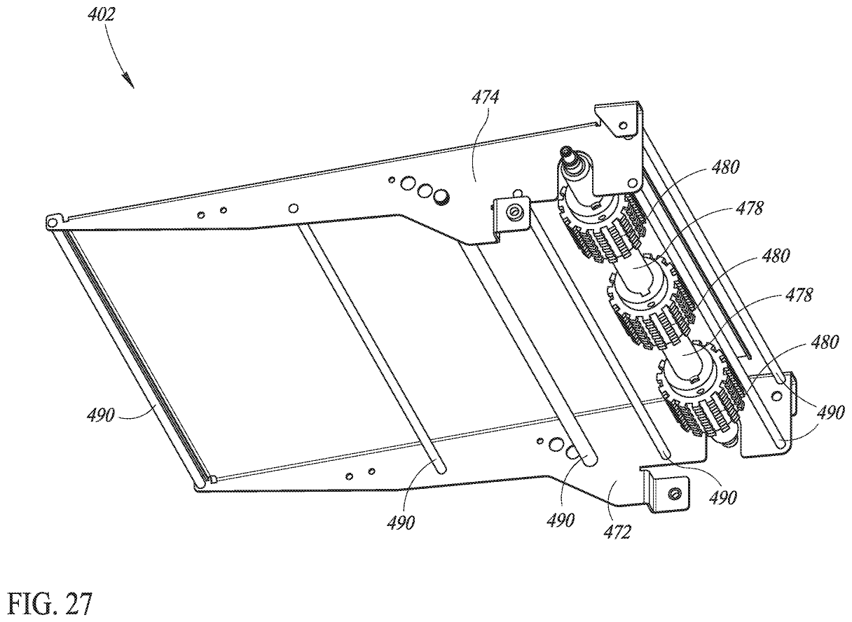

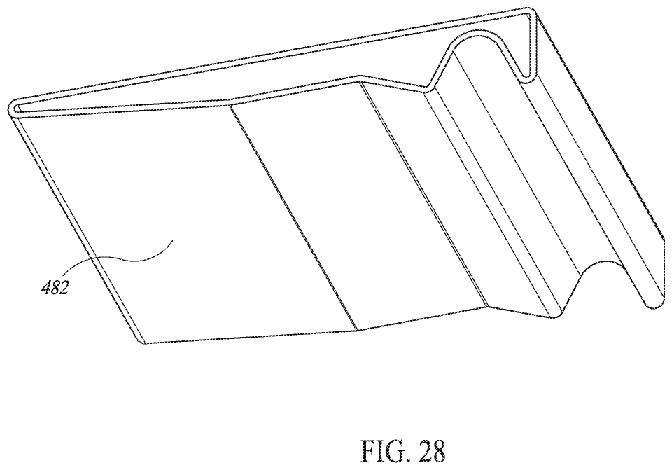

FIGS. 25 and 26 illustrate top and bottom perspective views, respectively, of the conveyor 402 with various components removed to more clearly illustrate the left and right side support rails 472, 474, the axle 478 and grippers 480, the conveyor belt 482, and one of the rollers 490. FIG. 27 illustrates a bottom perspective view of the conveyor 402 with various components including the conveyor belt 482 removed to more clearly illustrate the left and right side support rails 472, 474, the axle 478 and grippers 480, and the rollers 490. FIG. 28 illustrated a bottom perspective view of the conveyor belt 482 isolated from other components of the conveyor 402, to more clearly illustrate its path through the conveyor 402, which can be defined and restrained by the rollers 490 illustrated in FIG. 27.

In operation, the food-item transfer system 400 may be installed proximate to the intermediate conveyor belt 404, and the intermediate conveyor belt 404 may be installed proximate or adjacent to a primary conveyor belt 406. The primary conveyor belt 406 may be a terminal end portion of a larger automated assembly line for assembling cooked or uncooked food items such as pizzas 412. The intermediate conveyor belt 404 may act as a buffer between the primary conveyor belt 406 and the food-item transfer system 400. For example, food items carried by the primary conveyor belt 404 can be transferred from the primary conveyor belt 406 to the intermediate conveyor belt 404, then from the intermediate conveyor belt 404 to the conveyor 402 of the food-item transfer system 400, and then from the conveyor 402 to a shelf 108 of the rack 106. The intermediate conveyor belt 404 can be less than twenty, less than sixteen, less than twelve, or less than eight feet long in a direction aligned with a direction of its travel (because the intermediate conveyor belt 404 is looped, this means an overall length of the structure formed by the intermediate conveyor belt 404 can be less than ten, less than eight, less than six, or less than four feet long in a direction aligned with a direction of its travel).

Because the primary conveyor belt 406 is a portion of an assembly line for the food items, its speed is generally limited to the slowest portion of the assembly line and it generally cannot travel as fast as the conveyor belt 482 of the conveyor 402. Thus, in operation, the primary conveyor belt 406 may carry food items at a first speed dictated by the needs of the food item assembly line. Once a food item reaches the end of the primary conveyor belt 406 adjacent the intermediate conveyor belt 404, the intermediate conveyor belt 404 can be controlled to match the first speed of the primary conveyor belt 406. The food item can then be transferred from the primary conveyor belt 406 to the intermediate conveyor belt 404. Once the food item is located on the intermediate conveyor belt 404 and off the primary conveyor belt 406, the intermediate conveyor belt 404 can speed up to a second speed that is faster than the first speed and that is dictated by a maximum or most efficient operating speed for transferring food items between the intermediate conveyor belt 404 and the conveyor belt 482 of the conveyor 402.

The conveyor belt 482 of the conveyor 402 can be positioned adjacent to the intermediate conveyor belt 404 with the push bar 492 located at or near the entrance for the food item onto the conveyor 402. As the food item begins to transfer between the intermediate conveyor belt 404 and the conveyor belt 482 of the conveyor 402, the motor 476 can be operated to drive movement of the conveyor belt 482 at a speed matching the speed of the intermediate conveyor belt 404. The food item can then be transferred from the intermediate conveyor belt 404 to the conveyor belt 482 of the conveyor 402. Once the food item is located on the conveyor belt 482 of the conveyor 402 and off the intermediate conveyor belt 404, the intermediate conveyor belt 404 can slow down to the first speed and prepare to receive a subsequent food item from the primary conveyor belt 406, and movement of the conveyor belt 482 of the conveyor 402 can be stopped.

Once the food item is located entirely on the conveyor 402, the food-item transfer system 400 can be operated to move the food item away from the intermediate conveyor belt 404 and toward and adjacent to a shelf 108 of the rack 106. In doing so, sensors such as cameras can be used to image the food item on the conveyor 402 and sensors such as load cells can be used to measure the weight and distribution of the food item on the conveyor. Such information can be communicated from the sensors to the control system 420, and the control system 420 can analyze such information to detect faults or irregularities in the food item held by the conveyor 402. If a fault or an irregularity is detected or identified by the control system 420, such as based on the information provided by the sensors, then the operation of the food-item transfer system 400 as well as other upstream components of the food item assembly line can be halted to allow human operators to step in and investigate the fault or irregularity and/or manually operate the halted portions of the assembly line.

If no fault or irregularity is detected, then once the food item is adjacent the shelf 108, the food-item transfer system 400 can be operated to move the conveyor belt 482 of the conveyor 402 to move the food item toward and onto the shelf 108, until the food item is no longer on the conveyor belt 482 of the conveyor 402, and until the forward face 494 of the push bar 492 has pushed the food item further off the conveyor belt 482 and further onto the tray 108 than the conveyor belt 482 could achieve without the push bar 492. The conveyor 402 can then be returned to a position adjacent to the intermediate conveyor 404 to receive a subsequent food item.

While the food-item transfer system 400 is transferring the food item from the conveyor 482 to the shelf 108, a subsequent food item is travelling through the assembly line along the primary conveyor belt 406 and is transferred to the intermediate conveyor belt 404. A speed of operation of the food-item transfer system 400 as it transfers food from the intermediate conveyor belt 404 to the shelf 108 can be configured such that as the conveyor 402 returns to the position adjacent the intermediate conveyor belt 404 to receive the subsequent food item, the subsequent food item is ready to be transferred from the intermediate conveyor belt 404 to the conveyor 402. Such a process can repeat for as long as desired until a desired number of food items have been transferred to the shelves 108.

In some implementations, when an operator positions one or more racks 106 within the vicinity of the food-item transfer system 400, the operator can obtain an identification of the individual racks 106, such as by reading human-readable symbols or using a machine readable symbol reader to read machine readable symbols on the racks 106. Such identifications can be provided to the food-item transfer system 400 and using such identifications, the food-item transfer system 400 can retrieve information regarding the individual racks 106, including how many food items are to be transferred to each of the racks 106. The food-item transfer system 400 and/or the individual racks 106 can include one or more lights that can be illuminated when the respective racks 106 are almost completely loaded with food items or are completely loaded with food items.

The control system 420 may check for and/or detect errors or irregularities in the identities of the racks 106 installed within the vicinity of the food-item transfer system 400 and/or in received instructions for loading the food items onto the racks 106. For example, the control system 420 may check for or detect that the food-item transfer system 400 has been instructed to load a food item onto a rack 106 that is full, or to load a food item onto a rack 106 that has not been installed within the vicinity of the food item transfer system 400. Upon detection of such an error or irregularity, the operation of the food-item transfer system 400 as well as other upstream components of the food item assembly line can be halted to allow human operators to step in and investigate the fault or irregularity and/or manually operate the halted portions of the assembly line.

In some implementations, the control system 420 can receive a signal from the food-item assembly line indicating that a specific food item, such as a specific uncooked pizza, has been identified or labeled a reject. Such an identification or label can be assigned, for example, after a defect or irregularity is detected by a metal detector, a vision system, an X-ray system, a weight checking system, or another safety or quality checking system. In response to receipt of such a signal, the control system 420 can control the food-item transfer system 400 to discard the specific food item and to transmit a signal that the specific food item should be remade.

In some implementations, an operator can position one or more racks 106 side-by-side within the vicinity of the food-item transfer system 400 on one or more side-by-side frames similar to the frame 306. Such frames can have two, three, four, five, six, eight, ten, twelve, or more bays for receiving two, three, four, five, six, eight, ten, twelve, or more respective racks 106. Such frames can by themselves or collectively form a straight line of bays for receiving racks 106, a U-shape of bays for receiving racks 106, an L-shape of bays for receiving racks 106, or a circular or semi-circular shape of bays for receiving racks 106, arranged about the food-item transfer system 400. Each such frame can include four respective adjustable legs, where a length of each of the legs is adjustable to allow an operator to level the frame.

Each bay of each of the frames can include a docking station similar to that described herein for the appliance 102, including features corresponding to the horizontal support surface 114, the pin 120, the latching system 122, and the rails 156 and 158, for retaining a rack 106 within the bay. Each bay of each of the frames can also include a proximity sensor coupled to a top end portion thereof and configured to detect that a rack 106, as opposed to a human being or other object, has been positioned within the bay. Each bay of each of the frames can also include a light curtain positioned relatively behind the respective proximity sensor within the respective bay and configured to detect that an object such as a rack 106 or a human being has been positioned within the bay.

If the light curtain detects that an object has been positioned within the respective bay but the respective proximity sensor does not, then an alert can be generated to indicate that an error or irregularity or potential safety issue may have arisen, and operation of the food-item transfer system 400 as well as other upstream components of the food item assembly line can be halted to allow human operators to step in and investigate the fault or irregularity and/or manually operate the halted portions of the assembly line. If the light curtain and the respective proximity sensor both detect that an object has been positioned within the respective bay, then such an alert may not be generated and operation of the food-item transfer system 400 can proceed as normal.

Each bay of each of the frames can also include a set of visible lights and/or audible buzzers to indicate a status of a rack 106 within the respective bay. For example, in some implementations, no lights and no buzzers may be activated if a rack 106 is not positioned within the respective bay, or if a rack 106 is positioned within the respective bay but the rack 106 does not have a recognizable human readable or machine readable identification. As another example, a single green light may be activated if a rack 106 is positioned within the respective bay but has not yet been completely locked to the docking station of the bay. As another example, one or two green lights may be activated if a rack 106 is positioned within the respective bay and has been completely locked to the docking station of the bay. As another example, a yellow or orange light may be activated if a rack 106 is being loaded with food items and is almost completely full of food items. As another example, a flashing red light may be activated if a rack 106 is completely full of food items. As another example, an audible buzzer may be activated if an error or irregularity is detected within the respective bay.

In some implementations, the timing of the activations of the various lights and buzzers can be recorded for later analysis of the performance and efficiency of the overall system. Such information can be displayed, for example, on a human-machine interface such as a touchscreen device. Such a device can also allow a human operator to control or monitor operation of the food-item transfer system 400 and track the status of the racks 106 within each of the bays of each of the frames, such as to monitor the type of pizza positioned on each shelf 108 of each rack 106.

In some implementations, the food-item transfer system 400 may include the control system 420. The control system 420 may take the form of any current or future developed computing system capable of executing one or more instruction sets. As discussed in more detail below, the control system 420 may include a processing unit, a system memory and a system bus that communicably couples various system components including the system memory to the processing unit. The control system 420 will at times be referred to in the singular herein, but this is not intended to limit the embodiments to a single system, since in certain embodiments, there will be more than one system or other networked computing device involved. In some implementations, the control system 420 may provide network communication capabilities to communicate with other devices and/or components via a communications network. In some implementations, the control system 420 may be communicatively coupled with one or more of the motors and/or actuators that control the movement of the robotic appendage 410 and the conveyor 402. As such, the control system 420 may include one or more instructions that, when executed by the processor, cause the one or more motors, pistons, and/or other actuators to operate.

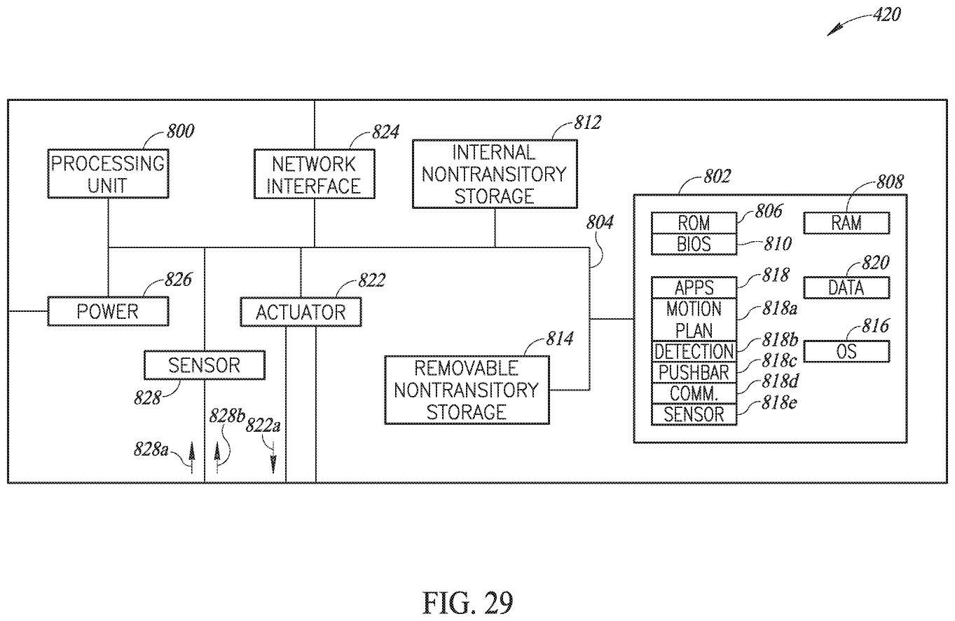

FIG. 29 and the following discussion provide a brief, general description of an exemplary control system 420 that may be implemented on the food-item transfer system 400. Although the control system 420 may be described herein as a functional element, one of ordinary skill in the art would readily appreciate that some or all of the functionality may be performed using one or more additional computing devices which may be external to the control system 420. Such computing devices may be included, for example, within a networked environment. The control system 420 may implement some or all of the various functions and operations discussed herein.

Although not required, some portion of the specific implementations will be described in the general context of computer-executable instructions or logic, such as d application modules, objects, or macros being executed by a computer. Those skilled in the relevant art will appreciate that the illustrated embodiments as well as other embodiments can be practiced with other computer system configurations, including handheld devices for instance Web enabled cellular phones or PDAs, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be stored in both local and remote memory storage devices and executed using one or more local or remote processors, microprocessors, digital signal processors, controllers, or combinations thereof.

The control system 420 may take the form of any current or future developed computing system capable of executing one or more instruction sets. The control system 420 includes a processing unit 800, a system memory 802, an actuator interface 822, a network interface 824, a power module 826, and a system bus 804 that communicably couples various system components including the system memory 802 to the processing unit 800. The control system 420 will at times be referred to in the singular herein, but this is not intended to limit the embodiments to a single system, since in certain embodiments, there will be more than one system or other networked computing device involved. Non-limiting examples of commercially available processing units and systems include, but are not limited to, an Atom™, Pentium™, or 80x86 architecture microprocessor as offered by Intel Corporation, a Snapdragon™ processor as offered by Qualcomm, Inc., a PowerPC™ microprocessor as offered by IBM, a Sparc™ microprocessor as offered by Sun Microsystems, Inc., a PA-RISC™ series microprocessor as offered by Hewlett-Packard Company, an A6™ or A8™ series processor as offered by Apple Inc., or a 68xxx™ series microprocessor as offered by Motorola Corporation.

The processing unit 800 may be any logic processing unit, such as one or more central processing units (CPUs), microprocessors, digital signal processors (DSPs), application-specific integrated circuits (ASICs), field programmable gate arrays (FPGAs), programmable logic controllers (PLCs), etc. In some implementations, the processing unit 800 may be communicatively coupled to one or more microcontrollers that provide signals to control one or more of the actuators. Unless described otherwise, the construction and operation of the various blocks shown in FIG. 29 are of conventional design. As a result, such blocks need not be described in further detail herein, as they will be understood by those skilled in the relevant art.

The system bus 804 can employ any known bus structures or architectures, including a memory bus with memory controller, a peripheral bus, and a local bus. The system memory 802 includes read-only memory (“ROM”) 806 and random access memory (“RAM”) 808. A basic input/output system (“BIOS”) 810, which can form part of the ROM 806, contains basic routines that help transfer information between elements within the control system 420, such as during start-up. Some embodiments may employ separate buses for data, instructions and power.

The control system 420 may include an actuator interface 822. Such an actuator interface 822 may be communicatively coupled, and may transmit one or more signals 822a to one or more motors, pistons, and/or other actuators that may be used to control the movement of one or more robotic appendages and/or portions of such robotic appendages. Such movement may be used to selectively extend and/or retract a robotic appendage or a component thereof. Such movements may be used to selectively rotate the robotic appendage to thereby position a conveyor to be longitudinally extended in a desired horizontal direction. In some implementations, the actuator interface 822 may include one or more microcontrollers that may be used to generate the signals 822a used to activate and/or control the one or more motors, pistons, and/or other actuators. In some implementations, the one or more microcontrollers may be part of or located proximate to the respective motor, piston, and/or other actuator being controlled.

In some embodiments, the control system 420 operates in an environment using one or more of the network interfaces 824 to optionally communicably couple to one or more remote computers, servers, display devices, and/or other devices via one or more communications channels. These logical connections may facilitate any known method of permitting computers to communicate, such as through one or more LANs and/or WANs. Such networking environments are well known in wired and wireless enterprise-wide computer networks, intranets, extranets, and the Internet.

The control system 420 may include a sensor interface 828. Such a sensor interface 828 may be communicatively coupled with, and may receive signals from, one or more of the sensors described herein. Such signals may include, for example, a detection signal 828a received from a sensor that indicates the presence of a horizontal surface, such as a conveyor, for example, proximate the food-item transfer system 400. Such signals may include, for example, a food-item detection signal 828b received from a sensor (e.g., an imager) that may be used by the control system 420 to detect the presence of a food item, and in some implementations, the type of food item, proximate the food-item transfer system 400. Such signals may be used by the control system 420 to identify or determine a type of action for the food-item transfer system 400 to take and/or a motion plan for the food-item transfer system 400 to implement.

The control system 420 also includes one or more internal nontransitory storage systems 812. Such internal nontransitory storage systems 812 may include, but are not limited to, any current or future developed persistent storage device. Such persistent storage devices may include, without limitation, magnetic storage devices such as hard disc drives, electromagnetic storage devices such as memristors, molecular storage devices, quantum storage devices, electrostatic storage devices such as solid state drives, and the like.

The control system 420 may also include one or more optional removable nontransitory storage systems 814. Such removable nontransitory storage systems 814 may include, but are not limited to, any current or future developed removable persistent storage device. Such removable persistent storage devices may include, without limitation, magnetic storage devices, electromagnetic storage devices such as memristors, molecular storage devices, quantum storage devices, and electrostatic storage devices such as secure digital (“SD”) drives, USB drives, memory sticks, or the like.

The one or more internal nontransitory storage systems 812 and the one or more optional removable nontransitory storage systems 814 communicate with the processing unit 800 via the system bus 804. The one or more internal nontransitory storage systems 812 and the one or more optional removable nontransitory storage systems 814 may include interfaces or device controllers (not shown) communicably coupled between nontransitory storage system and the system bus 804, as is known by those skilled in the relevant art. The nontransitory storage systems 812, 814, and their associated storage devices provide nonvolatile storage of computer-readable instructions, data structures, program modules and other data for the control system 420. Those skilled in the relevant art will appreciate that other types of storage devices may be employed to store digital data accessible by a computer, such as magnetic cassettes, flash memory cards, RAMs, ROMs, smart cards, etc.

Program modules can be stored in the system memory 802, such as an operating system 816, one or more application programs 818, and program data 820.

The application programs 818 may include, for example, one or more machine executable instruction sets (i.e., motion plans 818a) capable of causing the movement of the robotic appendage(s) and/or conveyor to process food items. Such movement may be cause, for example, by transmitting one or more signals to one or more actuators via the actuator interface 822. The application programs 818 may additionally include one or more machine executable instruction sets (i.e., detection module 818b) capable of providing detection instructions to detect food items, or other items, along a conveyor or other horizontal surface proximate the food-item transfer system 400. Such machine executable instruction sets may be responsive to one or more detection signals 824a received from one or more sensors via the network interface 824. Such detection signals 824a may include one or more food detection signals 824b that may be used to indicate the presence of a food item, including in some implementations an indication of the type of food item, proximate the food-item transfer system 400. The application programs 818 may also include any number of communications programs 818d to permit the control system 420 to access and exchange data with other systems or components via the network interface 824. The application programs 818 may additionally include one or more machine executable instruction sets (i.e., sensor module 818e) capable of detecting and processing signals received from one or more sensors.

Various embodiments of the devices and/or processes via the use of block diagrams, schematics, and examples have been set forth herein. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

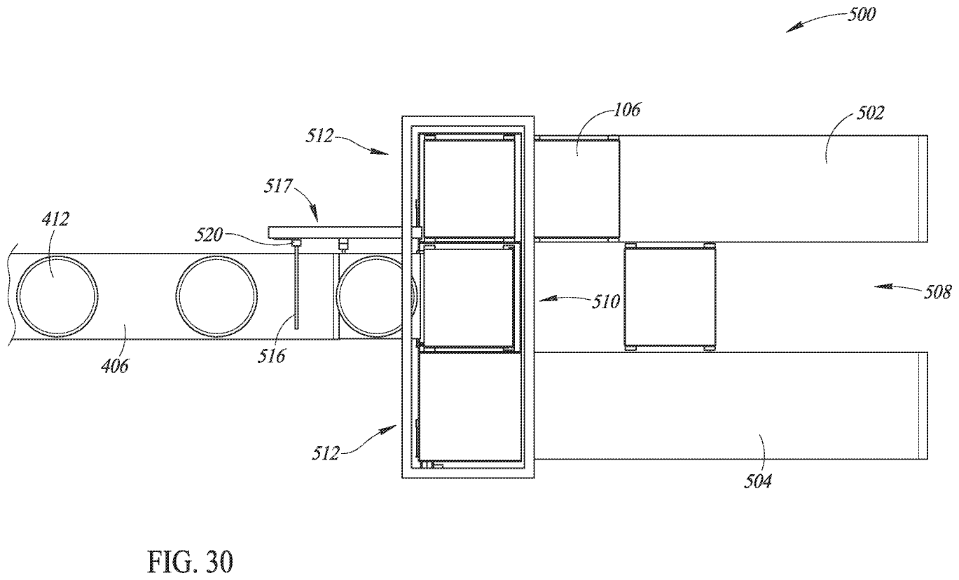

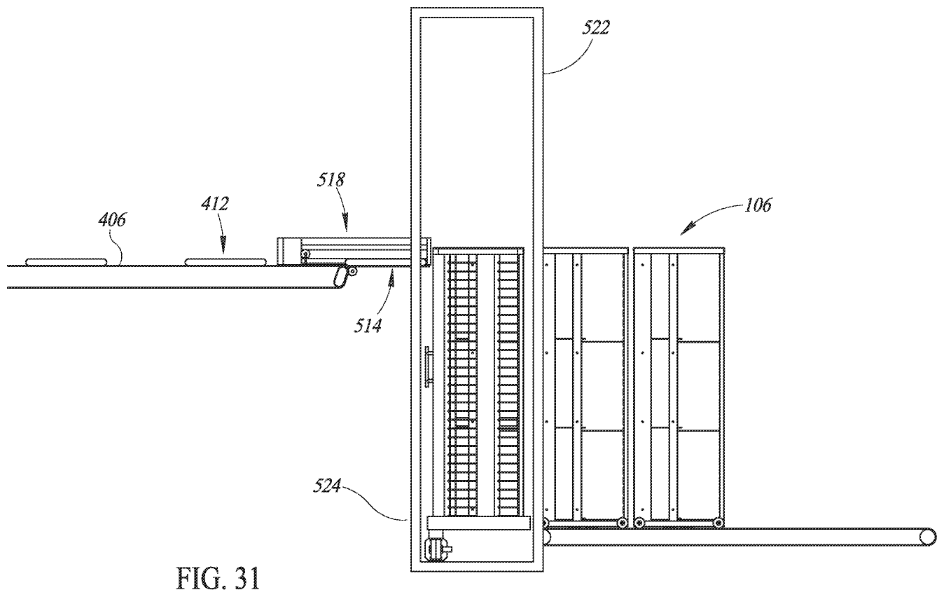

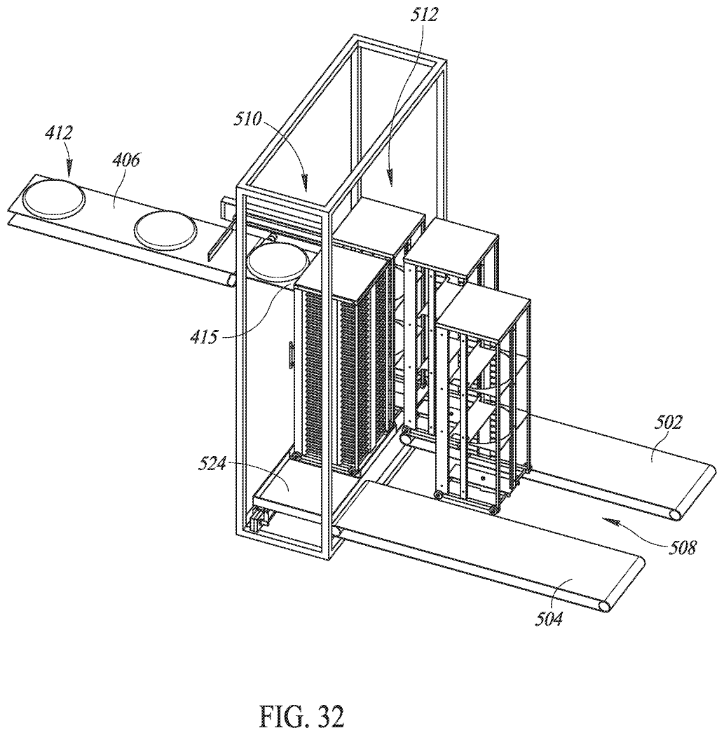

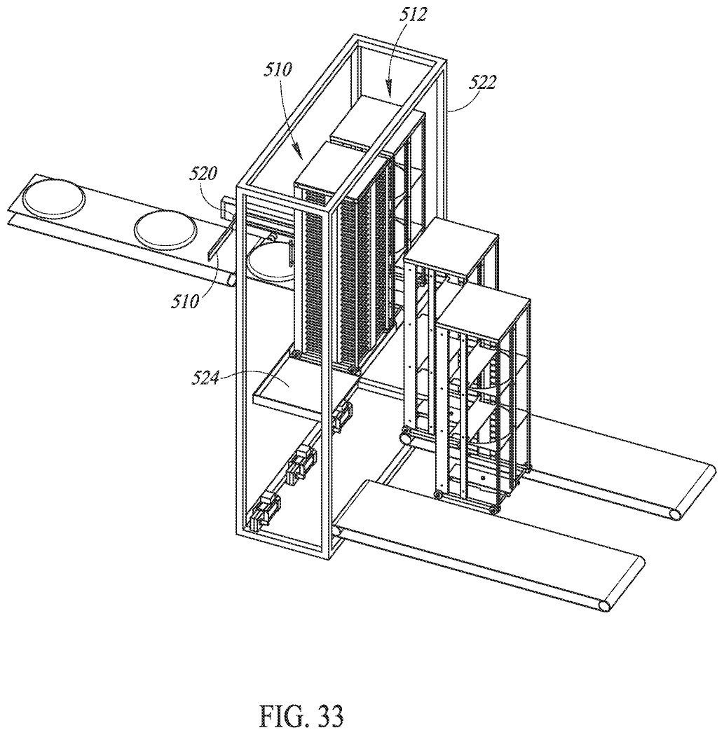

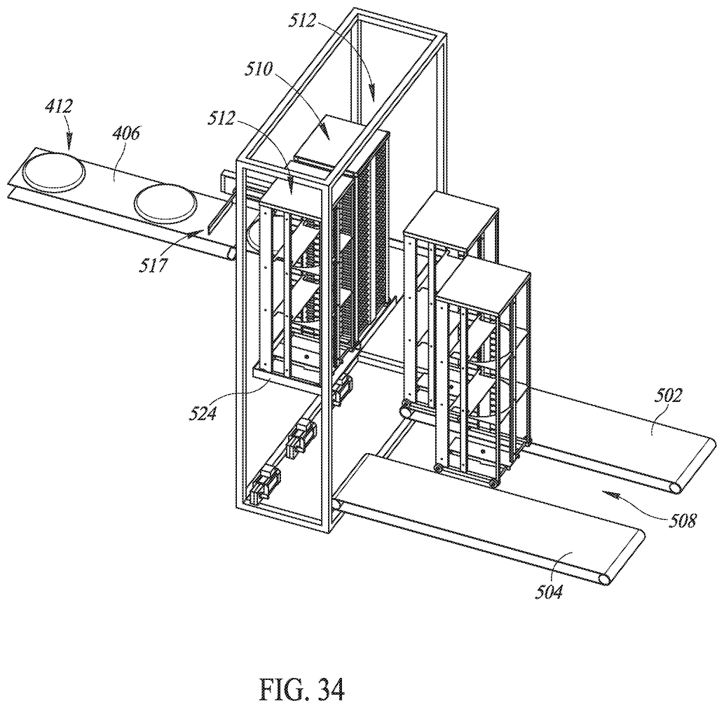

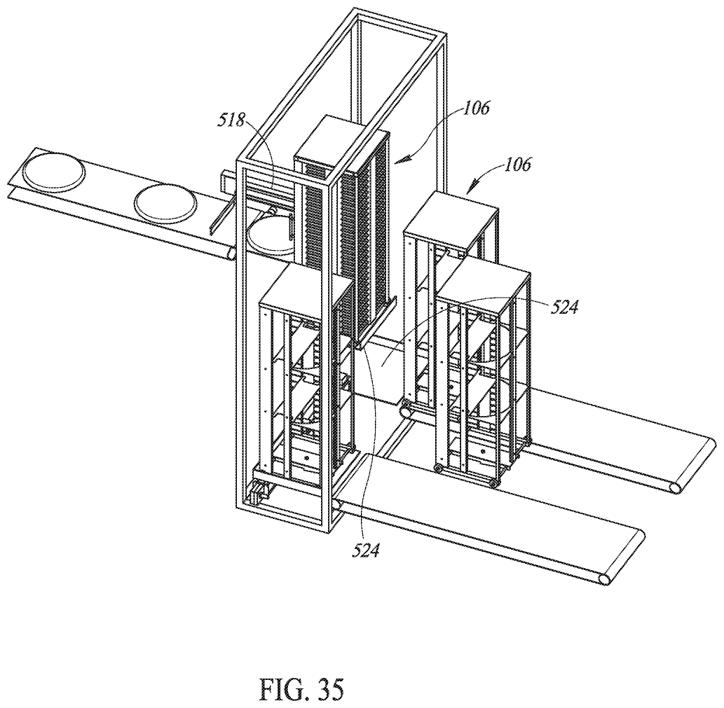

FIGS. 30 through 35 illustrate implementations of a rack feed system 500 which can be used in combination with implementations of a system for transporting food items described herein.

Implementations of a rack feed system 500 may include a first cart conveyor belt 502, a second cart conveyor belt 504, and an elevator assembly 506. Cart conveyor belts 502, 504 may be sized and dimensioned to accommodate a cart 106 situated thereon. One conveyor belt 502 may operate to feed a cart 106 into the elevator assembly 506 while the other conveyor belt may operate to discharge a cart 106 from the elevator assembly. A gap 508 may exist between the cart conveyor belts 502, 504, and gap 508 may be dimensioned to accommodate one or more carts 106 there between.

Elevator assembly 506 may include a central elevator 510 and one or more side elevators 512. Cart conveyor belts 502, 504 may be respectively aligned with a side elevator 512 while gap 508 may be aligned with the central elevator 510. Elevators 510, 512 may be housed in an elevator frame 522, and each elevator may include a raiseable platform 524. In some implementations, each platform 524 is independently raiseable while in other implementations one or more platforms may raise simultaneously.

Opposite gap 508, a dispensing shelf 514 may be aligned with central elevator 510 to load food items 412 onto a rack 106 positioned on central elevator 510. Food items 412 may be provided by a food conveyor belt 406 aligned with dispensing shelf 514. Food items 412 may be transferred from food conveyor belt 406 to dispensing shelf 514, and then from dispensing shelf 514 onto a rack shelf 108. Dispensing shelf 514 may be pivotable about a dispensing shelf axis 517 oriented laterally with respect to the food conveyor belt 406 and provided proximate to the longitudinal edge of food conveyor belt 406. Accordingly, dispensing shelf may be operated to tilt about shelf axis 517 downwards towards an adjacent rack shelf 108 thereby urging, by a gravity feed, food item 412 off dispensing shelf 514 and onto rack shelf 108. An articulated arm 516 may also be provided proximate to dispensing shelf 514. Arm 516 may be articulated or manipulated by various techniques, such as pneumatic, electromagnetic, or mechanical. Arm 516 may move longitudinally, in the direction with respect to the orientation of the food conveyor belt 406, to contact and push food items 412 onto dispensing shelf 514. Arm 516 may be connected to an arm track 518 by a rotatable cylinder 520. The rotatable cylinder 520 may also move along arm track 518 as described with respect to arm 516. Additionally, rotatable cylinder 520 may operate to rotate arm 514 so as to permit food items 406 to pass underneath arm 514 along food conveyor belt 412. Arm 516 may be positionable at a rest position proximate food conveyor belt 406 defined at a distance from dispensing shelf 514. In its rest position, arm 516 may contact or nearly contact a top surface of food conveyor belt 406 so as to block food items 412 from unintentionally entering dispensing shelf 514. In some implementations, arm 516 may further push food items 412 from dispensing shelf 514 onto a rack shelf 108. In other implementations, arm 516 may work in tandem with a pivoting dispensing shelf 514.

Rack feed system 500 may operate to fill a plurality of food items 412 into a plurality of rack 106, and more particularly onto the various rack shelves 108 vertically spaced within their respective rack 106. Rack 106 may be stored within gap 508. An empty rack 106 ready for loading may be placed on a feed conveyor belt 502. Transitioning the empty rack may be accomplished manually by a human operator or automatically, for instance by a roller or belt frictionally capturing and transitioning the rack 106 from gap 508 to feed conveyor belt 502. Rack 106 may then be transported from feed conveyor belt 502 onto the platform 524 for a side elevator 512. Rack 106 may then be moved from side elevator 512 to central elevator 510. Through control of the platform 524 for central elevator 510, rack 106 may be raised to intermittent or discrete vertical levels, and a food item 412 may be loaded into rack shelves 108 as described herein. Accordingly, elevator frame 524 may have a height of at least the height of a rack 106 when positioned at the highest elevation so as to load a food item 412 onto its lowest rack shelf 108. Once full, or as the operator may otherwise desire, the rack 106 containing food items 412 may be transitioned to side elevator 512 for subsequent discharge on the discharge cart conveyor belt 504. Transitioning rack 106 between elevator platforms 524 may occur by manually by the operator or automatically, for instance by installation of rollers or conveyor belts, or alternatively by adapting platforms 524 to be pivotable in the direction of adjacent platforms so as to cause the racks to roll between the elevators.

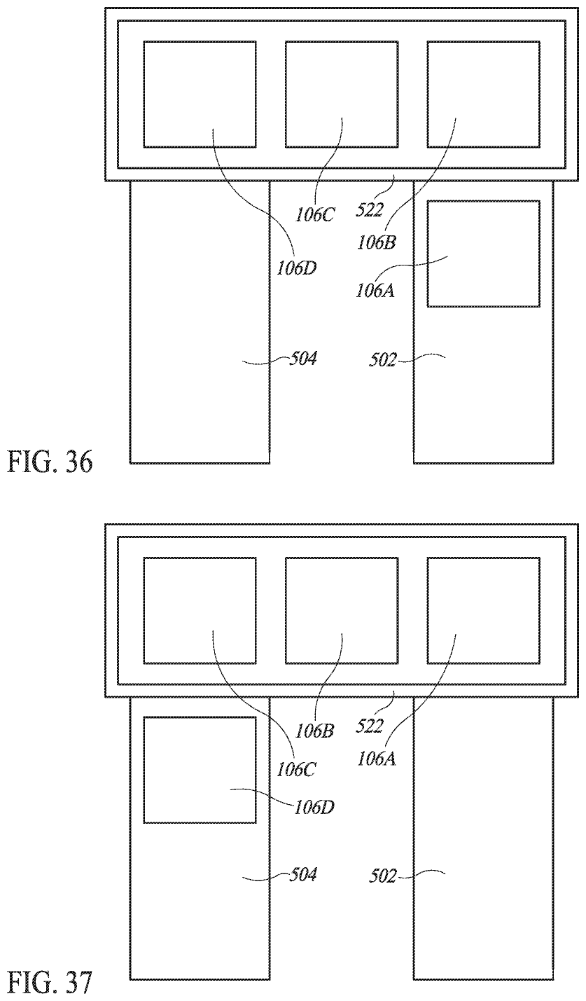

With reference now to FIGS. 36 and 37, a top view of an implementation of a rack feed system shows a plurality of rack 106A, 106B, 106C, and 106D transitioning between positions. FIG. 36 shows rack 106A, 106B, 106C, and 106D in a first position, and FIG. 37 shows rack 106A, 106B, 106C, and 106D in a second position. In the first position, rack 106A, 106B are empty, or at least partially empty, and awaiting food to be dispensed. Rack 106C is in progress of receiving food. Rack 106D has received food and is full, or at least partially full, with dispensed food and ready for ejection. In the second position, rack 106A has been moved to the right elevator, rack 106B has been moved to the central elevator, rack 106C has been moved to the left elevator, and rack 106D has been ejected on to conveyor belt 504. Rack 106C has now received food while rack 106B is in progress of receiving food.

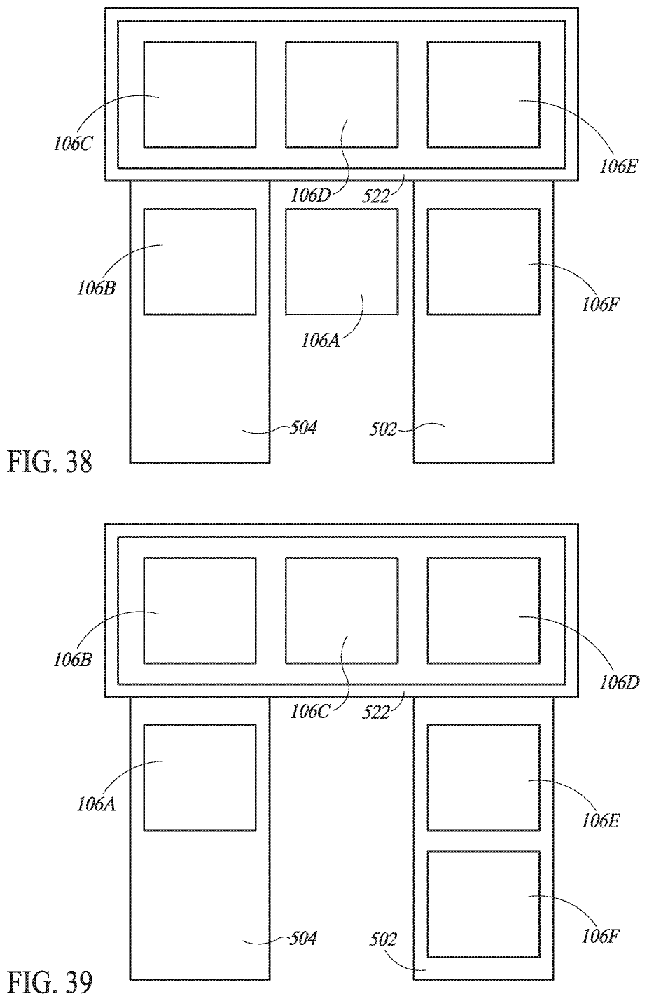

With reference now to FIGS. 38 and 39, a top view of an implementation of a rack feed system shows a plurality of rack 106A, 106B, 106C, 106D, 106E, 106F transitioning between positions. This implementation shows an implementation of a rack feed system capable of accommodating in excess of four or five racks, as shown in previous implementations. This implementation of accommodating five or more racks may be referred to as an overload or surge capacity implementation. In the first position, rack 106A, 106B, and 106C are empty, or at least partially empty, and awaiting food to be dispensed. Rack 106D is in progress of receiving food. Rack 106E, 106F have received food and are full, or at least partially full, with dispensed food. In the second position, rack 106E has been moved to conveyor belt 504, which is mutually accommodating both rack 106E, 106F. Rack 106A has been moved from the interim gap to conveyor belt 502, while rack 106B has been moved to the left elevator. Rack 106C has moved to the central elevator where food dispensing is in progress, and rack 106D has been filled, or nearly filled, with dispensed food and has moved to the right elevator. As should be appreciated, rack 106 may move to either the left or the right within elevator frame 522 so long as the platforms are of level height. As also should be appreciated, rack 106 may move clockwise or counterclockwise through elevator assembly 500, and likewise rack conveyor belts 502, 504 may be interchanged between the left and right sides of the assembly. For example, the implementation of FIGS. 36 and 37 depict rack 106 moving counterclockwise with conveyor 502 on the right side whereas the implementation of FIGS. 38 and 39 depict rack 106 moving clockwise with conveyor 502 on the right side.

Implementations of control system 420 may be employed to ensure timely, automatic filling of rack 106 with food items 412. As previously set forth, for example with reference to FIG. 26, control system 420 may influence, affect, or otherwise determine operation of the various electro-mechanical components including those of food rack system 500. For instance, control system 420 may operate to control intermittent, height adjustments of the central elevator 510 in time with operation of food conveyor belt 412, dispensing shelf 514, and/or pneumatic arm 516.

When logic is implemented as software and stored in memory, one skilled in the art will appreciate that logic or information, can be stored on any computer readable medium for use by or in connection with any computer and/or processor related system or method. In the context of this document, a memory is a computer readable medium that is an electronic, magnetic, optical, or other another physical device or means that contains or stores a computer and/or processor program. Logic and/or the information can be embodied in any computer readable medium for use by or in connection with an instruction execution system, apparatus, or device, such as a computer-based system, processor-containing system, or other system that can fetch the instructions from the instruction execution system, apparatus, or device and execute the instructions associated with logic and/or information. In the context of this specification, a “computer readable medium” can be any means that can store, communicate, propagate, or transport the program associated with logic and/or information for use by or in connection with the instruction execution system, apparatus, and/or device. The computer readable medium can be, for example, but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). Note that the computer-readable medium could even be paper or another suitable medium upon which the program associated with logic and/or information is printed, as the program can be electronically captured, via for instance optical scanning of the paper or other medium, then compiled, interpreted or otherwise processed in a suitable manner if necessary, and then stored in memory.

In addition, those skilled in the art will appreciate that certain mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

U.S. patent application Ser. No. 15/481,240, filed Apr. 6, 2017, U.S. provisional patent application No. 62/623,540, filed Jan. 29, 2018, and PCT patent application nos. PCT/US18/040714, filed Jul. 3, 2018, and PCT/US18/040730, filed Jul. 3, 2018, are hereby incorporated by reference herein in their entireties. The various embodiments described above can be combined to provide further embodiments. From the foregoing it will be appreciated that, although specific embodiments have been described herein for purposes of illustration, various modifications may be made without deviating from the spirit and scope of the teachings. Accordingly, the claims are not limited by the disclosed embodiments.

It will be clear that the systems and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. For example, in any of the embodiments shown, the shapes of the various components, such as the sheet metal strip 202, could be changed while still providing the same functionality of raising and lowering the release block 222 when the shuttle 104 is engaged with an appliance 102. For example, some or all of the sheet metal strip could be replaced with a rod to improve the stiffness of the linkage. Numerous other changes may be made which will readily suggest themselves to those skilled in the art and which are encompassed in the spirit of the disclosure.

What is claimed is:

1. A food transportation system, comprising:
a rack including a plurality of shelves, a first bottom end portion, and a first pin extending vertically at the first bottom end portion;
an appliance including a first latch sized to capture the first pin of the rack when the rack is positioned within the appliance, a second bottom end portion, and a second pin extending vertically at the second bottom end portion; and
a shuttle including a second latch sized to capture the second pin of the appliance when the shuttle is docked with the appliance, a cover, and a release block extending vertically through the cover;
wherein the rack includes a flange sized to capture the release block of the shuttle when the rack is positioned on the cover of the shuttle.

2. The food transportation system of claim 1 wherein the appliance controls the temperature of the rack when the rack is positioned within the appliance.

3. The food transportation system of claim 1, wherein the first pin extends through a recess from a center of the bottom end portion.

4. The food transportation system of claim 3 wherein the rack further includes a top plate provided at a top end portion opposite the first bottom end portion, the top plate supported by the plurality of columns.

5. The food transportation system of claim 4 wherein the rack further includes a plurality of stiffening plates parallel to the top plate.

6. The food transportation system of claim 5 wherein the stiffening plates are rectangular with a semi-circular portion thereof removed.

7. The food transportation system of claim 1 wherein the rack further includes readable symbols that uniquely identify the rack.

8. The food transportation system of claim 1 wherein the rack further includes a folded piece of sheet metal supported by a pair of axles at the first bottom end portion.

9. The food transportation system of claim 8 wherein the folded piece of sheet metal includes a first flange and a second flange, the first and second flanges extending downwardly.

10. The food transportation system of claim 9, wherein the first flange includes a first portion of constant height extending from the first axle to approximately the midpoint of the first flange.

11. The food transportation system of claim 9 wherein the second flange includes a first portion of constant height extending from the second axle to approximately the midpoint of the second flange.

12. The food transportation system of claim 8 wherein the folded piece of sheet is symmetric about a vertical central longitudinal axis of the rack.

13. The food transportation system of claim 1, further comprising a frame that can carry the rack.

14. The food transportation system of claim 13 wherein the frame includes a plurality of shafts including:
a front end shaft that extends side-to-side across a front end of the frame,
a rear end shaft that extends side-to-side across a rear end of the frame,
a left side shaft that extends front-to-back across a left side of the frame, and
a right side shaft that extends front-to-back across a right side of the frame.

15. The food transportation system of claim 14 wherein the frame further includes a left side handle coupled to a front corner of the frame where the front end shaft meets the left side shaft and to a rear corner of the rack where the rear end shaft meets the left side shaft.

16. The food transportation system of claim 14 wherein the frame further includes:
a left side outer rail that extends adjacent to and along the left side shaft, and
a left side inner rail that extends front-to-back from approximately a center of the front end shaft to approximately a center of the rear end shaft.

17. The food transportation system of claim 16 wherein the frame further includes:
a right side outer rail that extends adjacent to and along the right side shaft, and
a right side inner rail that extends front-to-back from approximately the center of the front end shat to approximately the center of the rear end shaft.

18. A method for moving a plurality of food items, including a first food item and a second food item, the method comprising:
carrying the first food item through a food item assembly line on a conveyor belt toward a terminal end of the conveyor belt;
transferring the first food item from the terminal end to a dispensing shelf;
tilting the dispensing shelf towards a cartridge positioned on a platform at a first height level;
raising the platform to a second height level;
carrying the second food item through the food item assembly line on the conveyor belt toward the terminal end of the conveyor belt;
transferring the second food item from the terminal end to the dispensing shelf, and
tilting the dispensing shelf towards the cartridge positioned on the platform at the second height level.

19. The method of claim 18, wherein transferring the first food item includes contacting the first food item with a movable arm and using the movable arm to push the first food item from the terminal end to the dispensing shelf, and
wherein transferring the second food item includes contacting the second food item with the movable and using the movable arm to push the second food item from the terminal end to the dispensing shelf.

20. A system for transporting food items comprising:
a rack having a plurality of shelves within a frame on a plurality of wheels; and
a transportation shuttle having:
a shuttle base having a bottom and a cover;
a set of wheels or treads coupled to the bottom of the base;
a release block that extends through the cover, the release block selectively engageable via a flange of the rack to secure the rack to the shuttle via the release block of the shuttle when the rack is positioned on the cover of the shuttle base; and
a first latch that extends from a first end of the base and which is operable to capture a pin of a food preparation appliance when the shuttle is engaged with the food preparation appliance.
